(19) United States
(12) Patent Application Publication
(10) Pub. No.: US 2026/0221880 A1
(43) Pub. Date: Jul. 30, 2026

(54) POWER SUPPLIES FOR PULSED POWER APPLICATIONS

(71) Applicant: TAE Technologies, Inc., Foothill Ranch, CA (US)

(72) Inventors: Mikhail SLEPCHENKOV, Foothill Ranch, CA (US); Roozbeh NADERI, Foothill Ranch, CA (US); Hessamaldin ABDOLLAHI, Foothill Ranch, CA (US); Arash KHOSHKBAR-SADIGH, Foothill Ranch, CA (US)

(21) Appl. No.: 19/144,605

(22) PCT Filed: Dec. 22, 2023
(86) PCT No.: PCT/US2023/085716

§ 371 Date: Jun. 30, 2025

Related U.S. Application Data
(60) Provisional application No. 63/436,396, filed on Dec. 30, 2022.

(51) Int. Cl. H02M 3/158; H02J 7/00; H02J 7/34

(52) U.S. Cl. CPC H02M 3/1582; H02J 7/855; H02M 3/1586; H02J 7/345

(57) ABSTRACT

Example embodiments of systems, devices, and methods are provided herein for power supply systems that are configured to generate pulsed power for loads. The power supply systems can include cascaded power supply units that each include cascaded power supply cells. Each power supply cell can include parallel boost converters for regulating a power bus and a buck converter for converting energy on the bus to a regulated output voltage and current.

### CROSS-REFERENCE TO RELATED APPLICATIONS

This application claims the benefit of and priority to U.S. Provisional Application Ser. No. 63/436,396 filed Dec. 30, 2023, which is incorporated by reference herein for any and all purposes.

### FIELD

The subject matter described in this document relates generally to power supplies for pulsed power applications.

### BACKGROUND

Pulsed power generally refers to the release of high voltage and current to a load over a short period of time. Electrical energy can be accumulated by energy sources over a longer period of time and provided to the load in a short, but high energy, pulse. In general, the energy released by the energy sources may not have the appropriate voltage or current level for the load. Power converters can be used to regulate the voltage and/or current released by the energy source and provided to the load.

In electrical engineering, power engineering, and the electric power industry, power conversion is converting electrical energy from one form to another (e.g., converting between AC and DC, adjusting the voltage or frequency, or some combination of these). A power converter is an electrical or electro-mechanical device for converting electrical energy. A power converter can be as simple as a transformer to change the voltage of AC (i.e., alternating current) power, but can also be implemented using far more complex systems. The term “power converter” can also refer to a class of electrical machinery that is used to convert one frequency of alternating current into another frequency. Power conversion systems often incorporate redundancy and voltage regulation.

Power converters often include semiconductor switches and filter components to convert the electrical energy. Higher voltages and currents typically require larger and more complex components that may also cause larger ripple currents on the output of the converters, which may negatively impact the load. In addition, the higher voltages and currents subject the components of power converters to excessive stress, resulting in component failure, reduced performance, and/or shorter lifespans.

For these and other reasons, a need exists for improved systems, methods, and devices for provided pulsed power to loads.

### SUMMARY

Example embodiments of systems, devices, and methods are provided herein for providing pulsed power to loads, including in stationary and mobile applications. The embodiments described herein can include power supply cells that include one multiple power converters with at least a portion of the converters being electrically coupled in parallel. For example, a power supply cell can include multiple parallel boost converters configured to increase the voltage of electrical energy output by an energy source. Each boost converter can be electrically coupled in parallel with a respective energy source. To deliver a pulse of power to a load, each boost converter can discharge its energy source, increase the voltage of the energy output by the energy source, and apply the voltage-adjusted energy to a power bus, e.g., a direct current (DC) power bus. The parallel boost converters enable the total current of the power bus to be distributed between the boost converters, enabling the converters to have switches with lower current ratings and extending the life of the switches. The number of parallel boost converters can be selected based on the target power bus current and switch current ratings for the power supply cell.

Each power supply cell can also include a buck converter electrically coupled between the power bus and the output of the power supply cell, e.g., between the last parallel boost converter and the output of the power supply cell. The buck converter can regulate the output voltage and/or output current of the power supply cell. The buck converter can be an interleaved buck converter with multiple phases. Using a phase shift in this way reduces the ripple current present on the output of the power supply cell and splits the total current of the power bus between multiple branches of switches. This enables the buck converter to have switches with lower current ratings and extends the life of the switches, similar to those of the boost converters.

A power supply system can include multiple power supply units electrically coupled in a cascaded arrangement. Each power supply unit can include one or more power supply cells. In implementations that include multiple power supply cells, power supply cells of a power supply unit can be electrically coupled in a cascaded arrangement. The power supply cells of a power supply unit can also be phase shifted to further reduce any ripple current on the electrical energy supplied to the load, which can also reduce the output capacitance of each power supply cell. The multiple power supply units and their power supply cells allow the power supply system to output regulated voltages in larger voltage range, e.g., from low voltages (e.g., less than 1 kV) to high voltages (e.g., 50 kV or higher).

The combination of cascaded power supply units that have phase-shifted power supply cells with parallel boost converters and an interleaved buck converter allows for tight voltage and current regulation over a large voltage range with low ripple currents, while using lower voltage and current rated switches within the converters, less output capacitance (and thus, smaller capacitors) for each power supply cell, and less output inductance (and thus, smaller inductors) for each power supply cell. The lower output capacitance also reduces the amount of energy stored by the output capacitors, which reduces the amount of energy released to the load, if any, during a short circuit event.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a block diagram depicting an example embodiment of a power supply system.

FIG. 2 is a block diagram depicting an example embodiment of a cell array.

FIG. 3A is a block diagram of an example embodiment of a power supply cell.

FIGS. 3B-3D are schematic diagrams of example embodiments of power supply cells.

FIGS. 4A-4D are schematic diagrams of example embodiments of cell arrays.

FIG. 5 is a plot depicting example output voltage and output current of a power supply cell.

FIG. 6 is a plot depicting example inductor currents of a power supply cell.

FIG. 7 is a plot depicting example inductor voltages and currents of a buck converter of a power supply cell.

FIG. 8 is a flow diagram depicting an example embodiment of a method of providing pulsed power to a load.

### DETAILED DESCRIPTION

Before the present subject matter is described in detail, it is to be understood that this disclosure is not limited to the particular embodiments described, as such may, of course, vary.

The terminology used herein is for the purpose of describing particular embodiments only, and is not intended to be limiting, since the scope of the present disclosure will be limited only by the appended claims.

### Examples of Applications

Stationary applications are those in which a power supply system is located in a fixed location during use, although it may be capable of being transported to alternative locations when not in use. The power supply system remains in a static location while providing pulsed electrical power for consumption by one or more other entities. Examples of stationary applications in which the embodiments disclosed herein can be used include, but are not limited to: energy systems for use by or within one or more residential structures or locales, energy systems for use by or within one or more industrial structures or locales, energy systems for use by or within one or more commercial structures or locales, and energy systems for use by or within one or more governmental structures or locales (including both military and non-military uses), energy systems for charging the mobile applications described below (e.g., a charge source or a charging station).

Mobile applications, sometimes referred to as traction applications, are generally ones where a power supply system is located on or within an entity, and stores and provides electrical energy for conversion into motive force by a motor to move or assist in moving that entity. Examples of mobile entities with which the embodiments disclosed herein can be used include, but are not limited to, electric and/or hybrid entities that move over or under land, over or under sea, above and out of contact with land or sea (e.g., flying or hovering in the air), or through outer space. Examples of mobile entities with which the embodiments disclosed herein can be used include, but are not limited to, vehicles, trains, trams, ships, vessels, aircraft, and spacecraft. Examples of mobile vehicles with which the embodiments disclosed herein can be used include, but are not limited to, those having only one wheel or track, those having only two-wheels or tracks, those having only three wheels or tracks, those having only four wheels or tracks, and those having five or more wheels or tracks. Examples of mobile entities with which the embodiments disclosed herein can be used include, but are not limited to, a car, a bus, a truck, a motorcycle, a scooter, an industrial vehicle, a mining vehicle, a flying vehicle (e.g., a plane, a helicopter, a drone, etc.), a maritime vessel (e.g., commercial shipping vessels, ships, yachts, boats or other watercraft), a submarine, a locomotive or rail-based vehicle (e.g., a train, a tram, etc.), a military vehicle, a spacecraft, and a satellite.

In describing embodiments herein, reference may be made to a particular stationary application (e.g., grid, micro-grid, data centers, cloud computing environments) or mobile application (e.g., an electric car). Such references are made for ease of explanation and do not mean that a particular embodiment is limited for use to only that particular mobile or stationary application. Embodiments of systems providing power to a motor can be used in both mobile and stationary applications. While certain configurations may be more suitable to some applications over others, all example embodiments disclosed herein are capable of use in both mobile and stationary applications unless otherwise noted.

### Power Supply System Examples

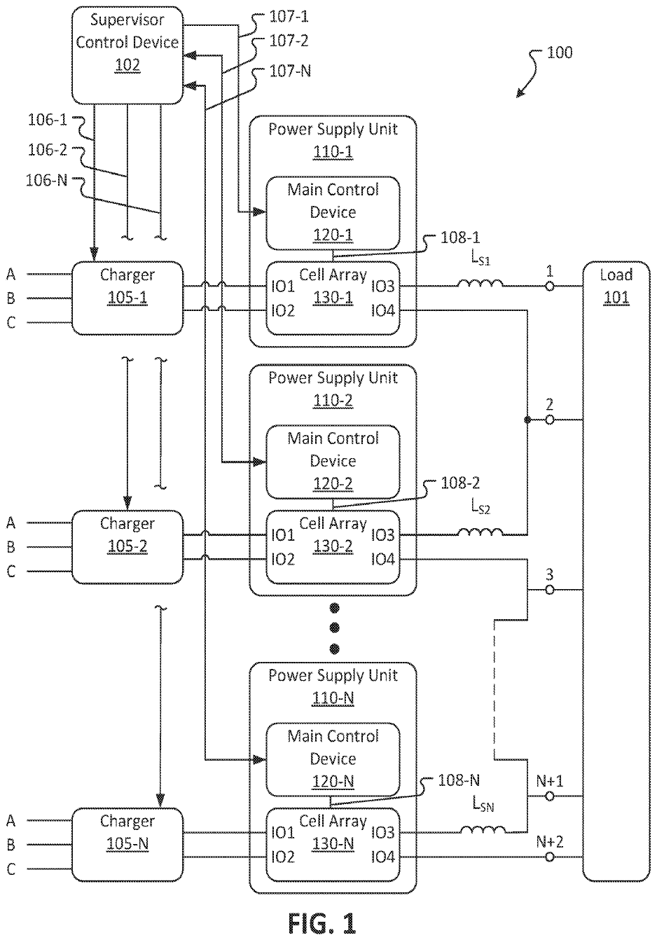

FIG. 1 is a block diagram depicting an example embodiment of a power supply system 100. Power supply system 100 includes a number “N” of power supply units 110-1 through 110-N and is configured to provide pulsed power to a load 101 through power connection ports 1 through N+2. Power connection ports described herein are also referred to a ports and can be implemented as, for example, terminals or connectors from which power can be output. Each power connection port 1 through N+2 can be electrically coupled to a corresponding power connection port of load 101. In some implementations, ports 1 through N+2 of power supply system 100 and the corresponding ports of load 101 are implemented as electrodes. Load 101 can be any type of load such as a beam steering devices, acoustic transducers, bioelectric devices, fusion reactor, plasma generators, grids, and so on.

Power supply system 100 includes a supervisor control device (SCD) 102 communicably coupled to chargers 105-1 through 105-N and power supply units 110-1 through 110-N. SCD 102 is communicably coupled to chargers 105-1 through 105-N over communication paths or links 106-1 through 106-N, respectively. SCD 102 is communicably coupled to power supply units 110-1 through 110-N over communication paths or links 107-1 through 107-N, respectively. Each power supply unit 110 includes a main control device (MCD) 120 to which SCD 102 is communicably coupled using communication path 107. Each MCD 120 is communicably coupled to a cell array 130 of its power supply unit 110 over communication links over a communication link 108.

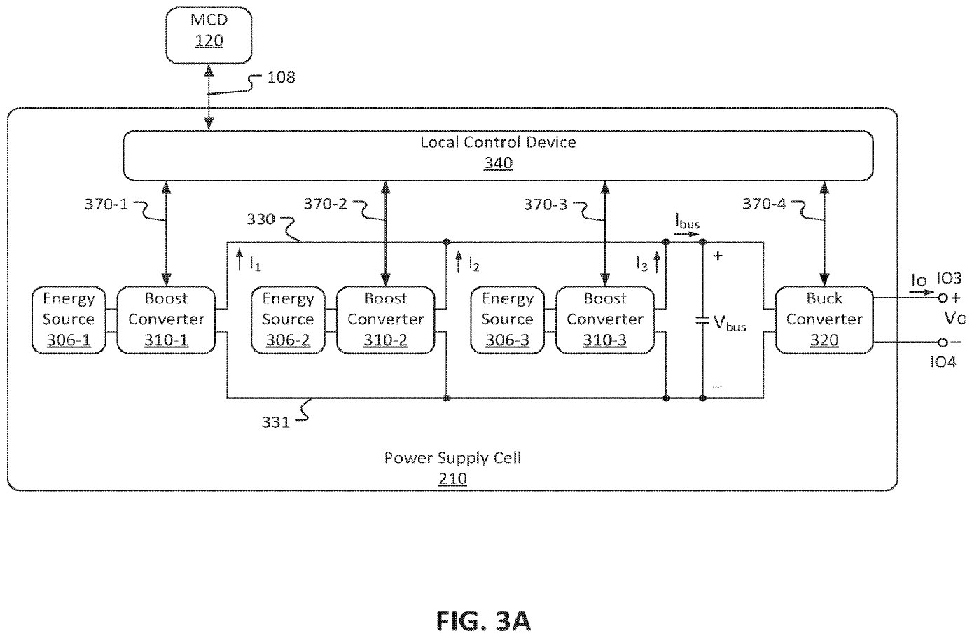

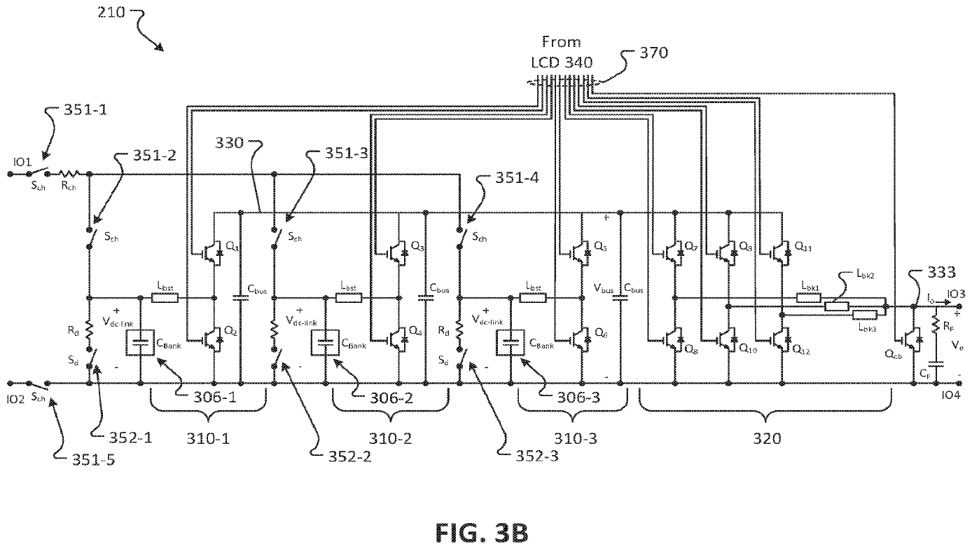

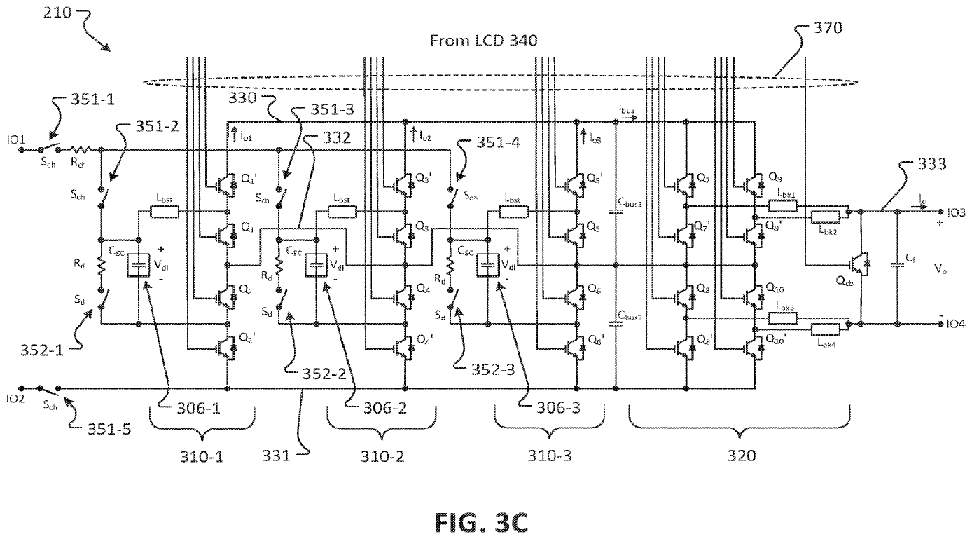

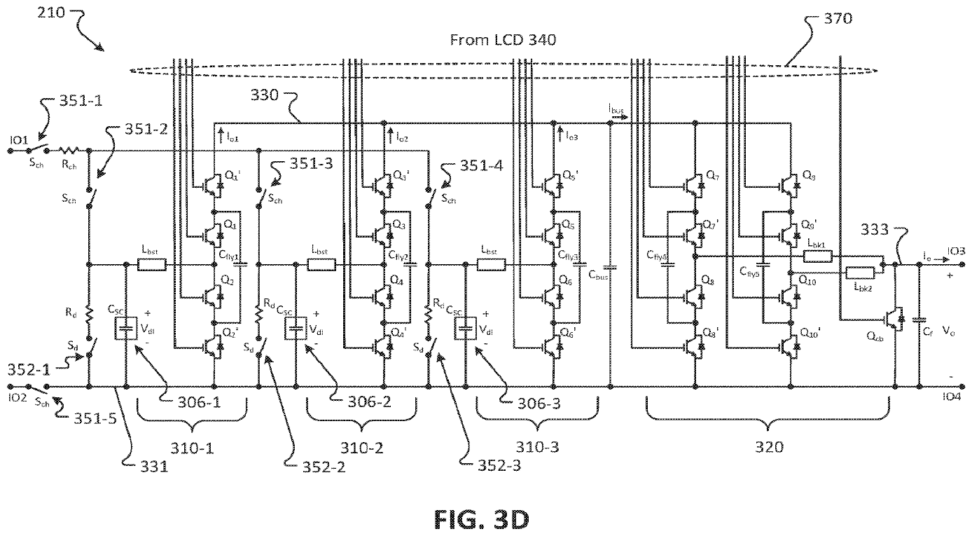

Communication paths or links 106, 107, 108, and 370 (FIG. 3A) can each be wired (e.g., electrical, optical) or wireless communication paths that communicate data or information bidirectionally, in parallel or series fashion. Data can be communicated in a standardized (e.g., IEEE, ANSI) or custom (e.g., proprietary) format. In automotive applications, communication paths 108 can be configured to communicate according to FlexRay or CAN protocols.

Power supply system 100 can include any number “N” of power supply units 110-1 through 110-N such that N is any number greater than or equal to one. Using multiple power supply units 110 connected in cascade with taps for ports between electrically coupled power supply units 110, as shown in FIG. 1, allows for a wider range of voltage levels and/or current levels to load 101 than using a single power supply unit 110.

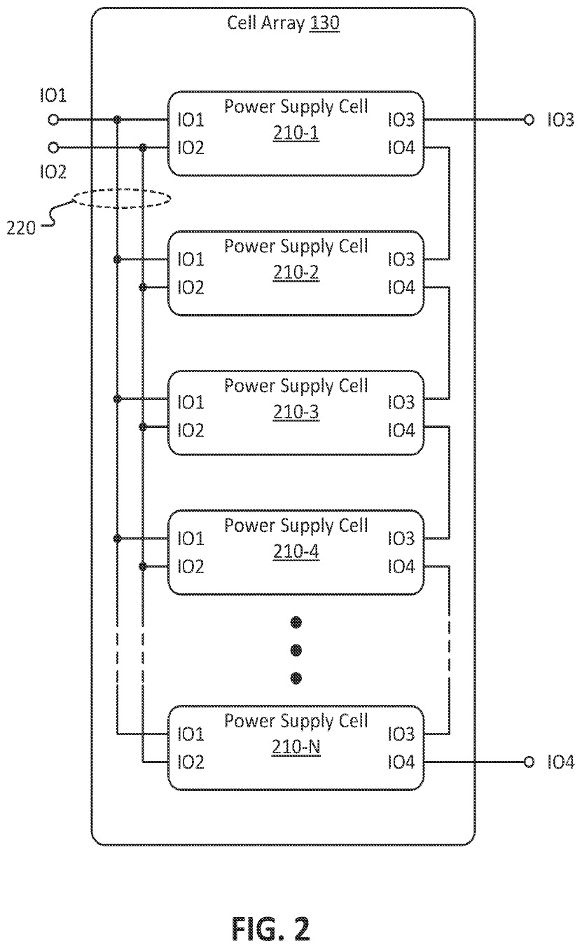

Each power supply unit 110 includes MCD 120 and a cell array 130. As described herein, each cell array 130 includes two or more power supply cells 210 (FIG. 2) that each include at least one energy source 306 and power converter 310 and/or 320 (FIGS. 3A through 3D) for outputting and regulating electrical energy output by energy source 306. In some embodiments, each power supply unit 110 can include a single power supply cell 210 rather than a cell array 130. MCD 120 can control converters 310 and 320 to release electrical energy from source 306 and regulate the electrical energy based on control signals received from SCD 102.

SCD 102 can execute control using software (instructions stored in memory that are executable by processing circuitry), hardware, or a combination thereof. SCD 102 can each include processing circuitry for executing the control and memory for storing the instructions. SCD 102 also includes communication interfaces for communication with chargers 105 and MCDs 120 over communication paths or links 106 and 107, respectively.

SCD 102 can send control signals to chargers 105 and MCDs 120 over communication paths or links 106 and 107, respectively. To charge energy sources 306 of power supply units 110, SCD 102 can send control signals to MCDs 120 to instruct MCDs 120 to operate one or more switches of each power supply cell 210 of its power supply unit 110 to electrical energy to pass from its charger 105 to its energy source 306. SCD 102 can also send control signals to chargers 105 to output energy to energy sources 306. Each charger 105 is electrically coupled to input/output ports IO1 and 102 of a cell array 130 of a corresponding power supply unit 110. As shown in FIG. 2, these ports IO1 and IO2 can be electrically coupled to each power cell 210 of cell array 130 to enable charging of energy source 306 of each power supply cell 210.

Each charger 105 can also be electrically coupled to another energy source, e.g., a grid, through one or more ports. In this example, the grid is a three-phase grid supplying power to ports A, B, and C. Charger 105 can include power converters configured to convert electrical energy from this external energy source to voltage and current levels suitable for charging energy sources 306 of power supply cells 210.

To output pulsed power to load 101, SCD 102 can send control signals to MCDs 120 to output a pulse of electrical energy at output ports IO3 and IO4 of its cell array 130. These control signals can include a synchronization signal that indicates when MCD 120 is to control its cell array 210 to output a pulse of electrical energy, a voltage reference signal that indicates a target voltage (e.g., digital or analog information, such as discrete values or a waveform, that may be normalized and static or time-varying) for the pulse of electrical energy, a current reference signal that indicates a target current (e.g., digital or analog information, such as discrete values or a waveform, that may be normalized and static or time-varying) for the pulse of energy, and/or a duration of the pulse of electrical energy. As described herein, MCD 120 can control power supply cell(s) 210 in its cell array 130 to output its pulse of electrical energy based on the received control signals. The synchronization signal can also indicate a duration of the pulse.

Cell arrays 130-1 through 130-N are electrically coupled in a sequential or cascaded arrangement such that the output voltage of cell arrays 130-1 through 130-N are combined, e.g., summed, across ports 1 and N+2. For example, if each cell array 130 outputs one kilovolt (kV) DC, the voltage between ports 1 and N+2 would be N kV. In this example, each cell array 130 outputs electrical energy at the same voltage level. However, cells arrays 130 can be operated to output electrical energy at different voltage levels. Power supply system 100 includes an output inductor Lₛ at the positive output of each cell array 130. Output inductors Lₛ reduce ripple currents at the output of each cell array 130.

Power supply system 100 also includes ports located at taps between cells arrays 130, e.g., ports 2, 3, and N+1. This provides flexibility in output voltage levels for load 101. For example, power supply system 100 includes port 2 between cell arrays 130-1 and 130-2. The voltage level between ports 2 and N+2 would be lower than the voltage level between ports 1 and N+2, assuming all cell arrays 130-1 through 130-N output electrical energy concurrently.

For example, if each cell array 130 outputs one kV DC, the voltage level between ports 1 and N+2 would be NkV DC, while the voltage level between ports 2 and N+2 would be (N-1) kV DC. Similarly, the voltage level between ports 2 and 3 would be lower than the voltage level between ports 1 and 3, assuming that both cells arrays 130-1 and 130-2 output electrical energy concurrently.

In this example, each port 1 through N+2 of power supply system 100 is electrically coupled to corresponding ports of load 101. In some embodiments, the ports of power supply system 100 that are electrically coupled to load 101 can be selected and/or adjusted based on the target input voltage to load 101. For example, power supply system 100 can include switches that can be controlled to route ports 1 through N+2 to ports of load 101.

As described in more detail herein, each power supply cell 210 and, thus each cell array 130, can be operated to output electrical energy having a range of voltage and current levels. For example, the duty cycles of converters 310 and 320 can be adjusted to adjust the output voltage and current levels of a power supply cell 210. In addition, some power supply units 110 and/or some power supply cells 210 can be disabled or bypassed for some pulses of electrical energy or for portions (e.g., a sub-duration of the full duration) of a pulse of electrical energy provided to load 101. This provides additional flexibility in the level of voltage and/or current provided to load 101 during a pulse of electrical energy.

For example, load 101 can be operated using a total two second pulse of electrical energy, where the first second is to have a voltage level of 10 kV DC and the last second is to have a voltage level of 5 kV DC. If power supply system 100 includes five power supply units 110 that can output 2 kV each, SCD 102 can control all five power supply units 110 to output 2 kV each during the first second of the pulse. SCD 102 can also control two power supply units 110 to output 2 KV each and a third power supply unit 110 to output 1 KV (e.g., by using only a portion of power supply cells 210 in its cell array 130 or controlling all power supply cells 210 to output reduced voltage levels) during the last second of the pulse.

Power supply system 100 can include various modular arrangements. For example, each power supply unit 110 can be packaged as a module, e.g., within a package or housing, that can be inserted into and removed from a rack, cabinet, EV compartment, or other support structure that includes ports for electrically coupling with ports of power supply unit 110, e.g., with ports of each cell array 130 of power supply unit and communication ports of each MCD 120. The ports of the support structure can be electrically coupled to SCD 102, chargers 105, and load 101 to enable swapping of power supply units 110 for power supply system 100.

Although shown separate from power supply units 110, each power supply unit 110 can include its charger, e.g., within the package or housing of power supply unit 110. In some embodiments, power supply system 100 may not include an individual charger 105 for each power supply unit 110. For example, a charger 105 can be electrically coupled to multiple power supply units 110 to charge energy sources 306 of each of the multiple power supply units 110.

FIG. 2 is a block diagram depicting an example embodiment of a cell array 130. Cell array 130 includes a number “N” of power supply cells 210. The number of power supply cells 210 in a cell array 130 can be the same as, or different from, the number of power supply units 110 in power supply system 110. For example, power supply system 100 can include four power supply units 110 that each include ten power supply cells 210. Other numbers of power supply units 110 and power supply cells 210 per cell array 130 can also be used. In addition, the number of power supply cells 210 can vary between cell arrays 130 of power supply system 120.

The outputs of power supply cells 210-1 through 210-N are electrically coupled in a cascade or series arrangement. In this way, the voltage level between ports IO3 and IO4 are a combination of, e.g., sum of, the individual output voltage of each power supply cell 210.

Cell array 130 includes a charging bus 220 that electrically couples each power supply cell 210 to ports IO1 and IO2, which electrically couples to a charger 105. Within each power supply cell 210, charging bus 220 is electrically coupled to each energy source 306 of the power supply cell 210, e.g., via switches as shown in FIGS. 3B through 3D. Charging bus 220 can be coupled to each cell 210 such that they are in parallel (as shown here), or alternatively such that they are in series, or a combination of the two.

As described herein, MCD 120 can control power supply cells 210 such that there is a phase shift between the output voltages and/or current of each power supply cell 210. This reduces the amount of ripple current on the output of cell array 130 at ports IO3 and IO4.

MCD 120 can also selectively enable and disable power supply cells 210-1 through 210-N for various output pulses. For example, if each power supply cell 210-1 through 210-N is configured to output up to 1 kV and SCD 105 has instructed MCD 120 to control the output of voltage to 5 kV for a particular output pulse or particular portion of an output pulse, MCD 120 can enable five power cells 210 during the particular output pulse or particular portion thereof, while disabling any other power supply cells 210 of cell array 130.

FIG. 3A is a block diagram of an example embodiment of a power supply cell 210.

Power supply cell 210 includes a local control device (LCD) 340, energy sources 306-1 through 306-3, and power converters 310-1 through 310-3 and 320. In this example, converters 310 are each a converter that increases the voltage output by the associated energy source 306 while reducing the current output by that source 306, while converters 320 are each a converter that decreases the voltage output by the associated energy source 306 while increasing the current output by that source 306. Boost and buck converters are example embodiments of converters 310 and 320, respectively, and for ease of discussion, converters 310 will be described herein as the example boost converters and converters 320 will be described herein as the example buck converters. However, other types of power converters can be implemented in the various embodiments.

Each boost converter 310 is configured to convert electrical energy stored by a corresponding energy source 306 and output the converted energy onto a power bus 330. For example, boost converter 310 is electrically coupled to energy source 306 and is configured to convert the electrical energy stored by energy source 306-1, e.g., by increasing the voltage level to a target voltage level for power bus 330, and output the converted electrical energy to power bus 330.

Energy source 306 can be an electrochemical battery, such as a single battery cell or multiple battery cells connected together in a battery module or array, or any combination thereof. Energy source 306 can also be a high energy density (HED) capacitor, such as an ultracapacitor or supercapacitor. An HED capacitor can be configured as a double layer capacitor (electrostatic charge storage), pseudocapacitor (electrochemical charge storage), hybrid capacitor (electrostatic and electrochemical), or otherwise, as opposed to a solid dielectric type of a typical electrolytic capacitor. The HED capacitor can have an energy density of 10 to 100 times (or higher) that of an electrolytic capacitor, in addition to a higher capacity. For example, HED capacitors can have a specific energy greater than 1.0 watt hours per kilogram (Wh/kg), and a capacitance greater than 10-100 farads (F). Energy source 306 can be configured as a single HED capacitor or multiple HED capacitors connected together in an array (e.g., series, parallel, or a combination thereof).

Energy source 306 can also be a fuel cell, which may not involve recharging. The fuel cell can be a single fuel cell, multiple fuel cells connected in series or parallel, or a fuel cell module. Examples of fuel cell types include proton-exchange membrane fuel cells (PEMFC), phosphoric acid fuel cells (PAFC), solid acid fuel cells, alkaline fuel cells, high temperature fuel cells, solid oxide fuel cells, molten electrolyte fuel cells, and others. Energy source 306 can be configured as a single fuel cell or multiple fuel cells connected together in an array (e.g., series, parallel, or a combination thereof). The aforementioned examples of source classes (e.g., batteries, capacitors, and fuel cells) and types (e.g., chemistries and/or structural configurations within each class) are not intended to form an exhaustive list, and those of ordinary skill in the art will recognize other variants that fall within the scope of the present subject matter.

In this embodiment boost converters 310-1 through 310-3 are electrically coupled in parallel with each other. Each boost converter 310 can output electrical energy having a same voltage level to power bus 330. In general, a boost converter 310 is a DC-DC converter that is configured to increase or step up the voltage level from its input to its output. In other embodiments boost converters 310 can be arranged in series, or a combination of parallel and series.

The parallel coupling of boost converters 310-1 through 310-3 enable boost converters 310-1 through 310-3 to share the current load of power bus 330. For example, if the target current for power bus is three kiloamps (kA), each boost converter 310-1 through 310-3 can be controlled by LCD 340 to output a current of 1 kA from its corresponding energy source 306 to power bus 330. Each boost converter 310-1 through 310-3 can be controlled to output a portion of the current or power bus 330, and each portion can be the same or different. By sharing the current load between multiple parallel boost converters 310, each boost converter 310 can output a lower current level such that lower current rated switches and/or other components can be used in each boost converter 310-1 through 310-3. The lower current levels also extend the life of the switches and/or other components of each boost converter 310-1 through 310-3.

Although, in this example embodiment, power supply cell 210 includes three boost converters 310-1 through 310-3, power supply cell 210 can include other numbers of boost converters 310 electrically coupled in parallel, e.g., more or fewer than three. For example, the number of boost converters 310 can be selected based on the target current level(s) for power bus 330 and/or current ratings (or desired current ratings) of the switches and/or other components of boost converters 310.

LCD 340 can receive control information from MCD 120 over communication link 108 and operate switches of boost converters 310-1 through 310-3 to output a target voltage and current to power bus 330. The control information can include a voltage reference signal that indicates a target voltage level for a pulse of electrical energy output by power supply cell 210, a current reference signal that indicates a target current level for the pulse of energy output by power supply cell 210, and/or a synchronization signal that indicates when LCD 120 is to control its converters 310-1 through 310-3 and 320 to output a pulse of electrical energy. The synchronization signal can also indicate a duration of the pulse.

LCD 340 can use (e.g., receive and process) the control signals to generate switch signals that control operation of converters 310-1 through 310-3 and 320. This switching controls the output voltage and current of converters 310-1-310-3 and 320, as described herein. LCD 340 can provide switching signals to converters 310-1 through 310-3 over communication paths or links 370-1 through 370-3, respectively. Similarly, LCD 340 can provide switching signals to converter 320 over communication path or links 370-4.

Buck converter 320 is configured to convert electrical energy between power bus 330 and ground 331 and output the converted energy to ports IO3 and IO4. In general, a buck converter 320 is a DC-DC converter that is configured to decrease or step down the voltage level from its input to its output. LCD 340 can control buck converter 320 using the switching signals to regulate the output voltage Vo and output current Io that is output by power supply cell 210.

MCD 120 can generate control information for each power supply cell 210 in its cell array 130 based on control signals received from SCD 105. In particular, MCD 120 can instruct, using control information, one or more LCDs 340 to begin outputting a pulse of energy based on the synchronization signal received from SCD 105. MCD 120 can also control the voltage and/or current levels of each power supply cell by providing the target voltage and current references to LCDs 340. For example, MCD 120 can determine the voltage and current references for each power supply cell 210 by dividing the target voltage and current for its cell array 130 (as provided in the control signals received from SCD 105) among power supply cells 210 of cell array 130. If the total voltage and/or current to be output by cell array 130 can be generated by less than all power supply cells 210 in cell array 130, MCD 120 can select a portion of power supply cells 210 in cell array 130 and provide control information to the selected power supply cells 210.

MCD 120 can also control power supply cells 210 to phase shift the electrical energy output by power supply cells 120 in its cell array 130. This can reduce the ripple current on the overall energy pulse output by power supply unit 110 that includes MCD 120 and cell array 130. In general, to introduce the phase shift, MCD 120 can generate synchronization information or timing information for each LCD 340 to offset the time at which each power supply cell 210 starts outputting its electrical energy. The phase information can indicate a phase angle for the output signal. The timing information can indicate a time delay after the energy pulse is to start (based on the synchronization information) that the power supply cell 130 is to start outputting electrical energy, causing a shift in time and phase shift of the output of each power supply cell 120.

MCD 120 and LCD 340 can execute control using software (instructions stored in memory that are executable by processing circuitry), hardware, or a combination thereof. MCD 120 and LCD 340 can each include processing circuitry for executing the control and memory for storing the instructions. MCD 120 also includes communication interfaces for communication with SCD 102 and LCD 340 over communication paths or links 107 and 108, respectively. LCD 340 includes a communication interface for communication with MCD 120 over communication path or link 108.

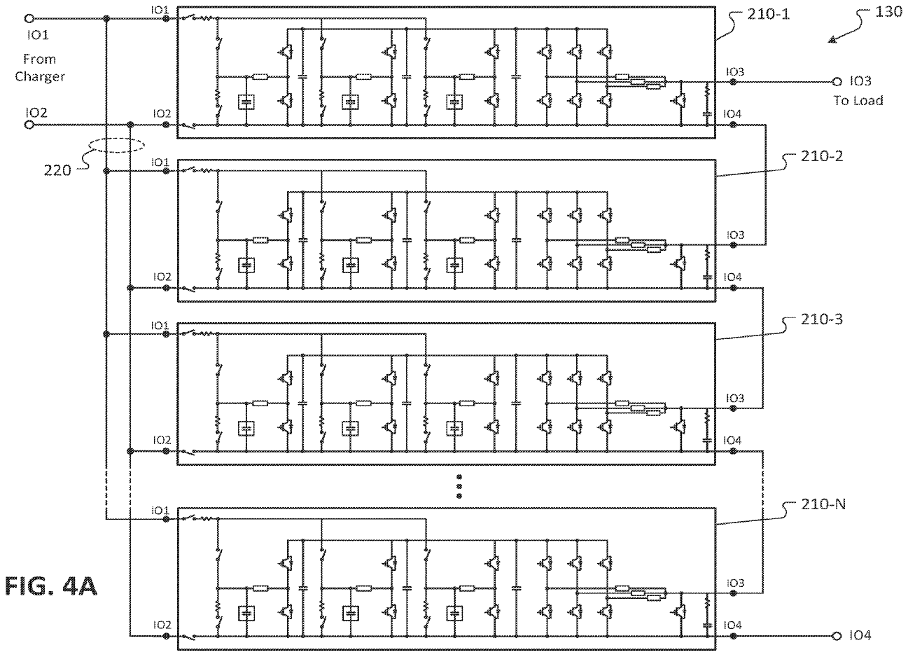

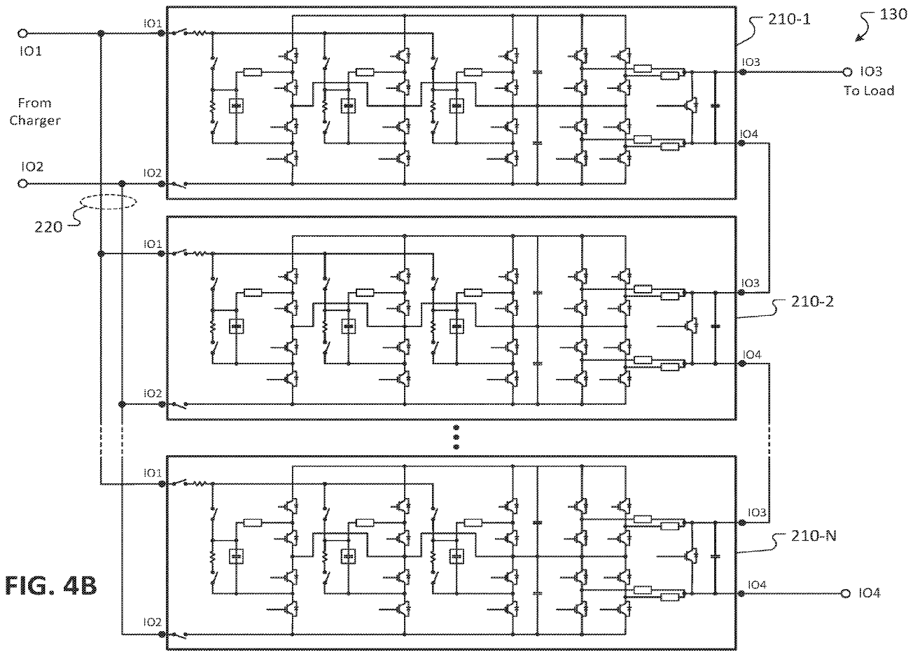

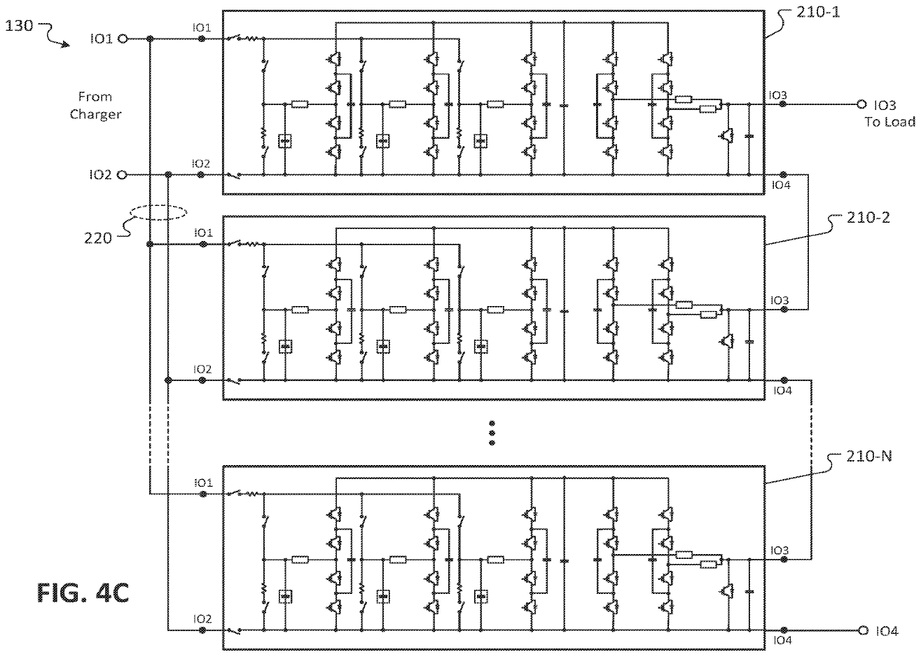

FIG. 3B is schematic diagram of an example embodiment of a power supply cell 210. For ease of description, in this and the embodiments described with respect to FIGS. 3C through 4C, energy sources 306-1 through 306-3 are (or include) one or more HED capacitors, e.g., ultracapacitor(s) and/or supercapacitor(s), although other types and/or configurations of energy sources 306 can be used. Each energy source 306-1 through 306-3 is electrically coupled in parallel with a corresponding boost converter 310-1 through 310-3, respectively.

In this example embodiment, each boost converter 310-1 through 310-3 is implemented as a two-level boost converter that includes a pair of switches (Q1 and Q2 for converter 310-1, Q3 and Q4 for converter 310-2, and Q5 and Q6 for converter 310-3), and an LC circuit having an inductor L_{Bst} electrically coupled between energy source 306 and the pair of switches and a capacitor C_{bus} electrically coupled between power bus 330 and ground 331.

Boost converters 310-1 through 310-3 are electrically coupled between power bus 330 and ground 331 and are electrically coupled in parallel with each other. In this way, boost converters 310-1 through 310-3 share the current load of power bus 330, enabling lower current rated switches Q1-Q6 to be used. Each boost converter 310-1 through 310-3 is configured to step up the voltage level of its energy source 306-1 through 306-3, respectively, and output the stepped up voltage to power bus 330.

Capacitor C_{bus} can operate as a filter capacitor for the boost stages that include boost converters 310-1 through 310-3. For example, capacitor C_{bus} can filter the DC bus voltage on power bus 330. Capacitor C_{bus} can also provide a buffer to stabilize the DC bus voltage present on power bus 330 whenever there are transients reflected at the input of the buck stage that includes buck converter 320 by the load dynamics at the output of the buck stage.

In this example embodiment, buck converter 320 is implemented as a two-level, three-phase buck converter. Buck converter 320 includes three pairs of switches (Q7 and Q8, Q9 and Q10, and Q11 and Q12) and an inductor L_{bk} electrically coupled between each pair of switches and an output bus 333 that is electrically coupled to port IO3. LCD 340 can control switches Q7-Q12 to shift the voltage and/or current output through each inductor L_{bk}. This phase shift reduces the ripple current on output bus 333 that is output by power supply cell 210 at ports IO3 and IO4. Reducing the ripple current enables smaller inductors L_{bk} (having smaller inductances) and a smaller filter capacitor C_{F} (having a smaller capacitance) at the output of power supply cell 210 than would be required for higher ripple currents. Having a smaller filter capacitor C_{F} reduces the amount of charge stored by filter capacitor C_{F}, which reduces the amount of current that would be released by the filter capacitor C_{F} to load 101 in the event load 101 experiences a short circuit condition.

Using multiple phases also enables buck converter 320 to use switches Q7-Q12 having lower current ratings than if a single phase buck converter was used. Using three phase as shown in this embodiment enables the total output current of power supply cell 210 to be split between the three phases such that each pair of switches pairs of switches (Q7 and Q8, Q9 and Q10, and Q11 and Q12) and their respective inductors L_{bk} pass one third of the total output current.

Power supply cell 210 also includes a switch Qcb, such as a crowbar switch, electrically coupled between output ports IO3 and IO4. A crowbar circuit, which can be implemented as a crowbar switch, is a circuit that short circuits the output of a power supply to prevent damage to circuit components when an overvoltage condition, overcurrent condition, short circuit condition, or other appropriate condition or event occurs. Switch Qcb can further reduce or prevent current of filter capacitor C_{F} from being released to load 101 during a short circuit event. If a short circuit is detected, LDC 340 can close switch Qcb by sending a switch signal to switch Qcb, which enables current released by filter capacitor C_{F} to flow through switch Qcb to ground rather than to load 101. Switch Qcb can also be used to bypass power supply cell 210, as described in more detail below.

Switches Q1 through Q12 and Qcb can be any suitable switch type, such as power semiconductors like the insulated gate bipolar transistors (IGBTs) shown here, metal-oxide-semiconductor field-effect transistors (MOSFETs), or gallium nitride (GaN) transistors.

Semiconductor switches can operate at relatively high switching frequencies, thereby permitting converters 310-1 through 310-3 and 320 to be operated in pulse-width modulated (PWM) mode if desired, and to respond to control commands within a relatively short interval of time. This can provide a high tolerance of output voltage regulation and fast dynamic behavior in transient modes. Semiconductor switches can include or not include an outside parallel diode, such as a body diode. In this embodiment, each switch Q1 through Q12 includes an outside parallel diode.

LCD 340 can operate switches 351-1 through 351-5 and 352-1 through 352-3 to selectively charge energy sources 306-1 through 306-3 and to output a pulse of electrical energy from energy sources 306-1 through 306-3. Switches 351-1 through 351-5 and 352-1 through 352-3 can be any suitable switch type, such as mechanical switches or power semiconductors, e.g., IGBTs, MOSFETs, or GaN transistors.

To charge energy sources 306-1 through 306-3, LCD 340 can open switches 352-1 through 352-3 and close switches 351-1 through 351-5 by providing switch signals to switches 352-1 through 352-3 and 351-1 through 351-5. This enables current to flow from charger 105 electrically coupled to ports IO1 and IO2 to energy sources 306-1 through 306-3. When charging energy sources 306-1 through 306-3, LCD 340 can open switches Q1 through Q12. Switches 351-1 and 351-5 isolate power cell 210 from charger 105 when energy sources 306-1 through 306-3 are not being charged. For example, LCD 340 can open switches 351-1 and 351-5 when energy sources energy sources 306-1 through 306-3 are not being charged to provide such isolation.

Switches 351-1 through 351-5 provide a charge circuit for each energy source 306-1 through 306-3. For example, switches 351-1, 351-2, and 351-5 provide a charge circuit for energy source 306-1; switches 351-1, 351-3, and 351-5 provide a charge circuit for energy source 306-2; and switches 351-1, 351-4, and 351-5 provide a charge circuit for energy source 306-3. The switches of each charge circuit are configured to selectively electrically couple its energy source to charger 105.

To release energy from energy sources 306-1 through 306-3, LCD 340 can close switches 352-1 through 352-3 and open switches 351-1 through 351-5 by providing switch signals to switches 352-1 through 352-3 and 351-1 through 351-5. For example, LCD 340 can operate switches 352-1 through 352-3 and 351-1 through 351-5 in this manner to release energy from energy sources 306-1 through 306-3 through resistors R_{d} (e.g., dump resistors) when power cell 210 is not in operation or in other conditions in which energy sources 306-1 through 306-3 should not be storing a charge. This prevents energy sources 306-1 through 306-3 from storing residual energy and ensures that power cell 210 is in a safe state when not in operation. The combination of switch 352 and resistor Ra in parallel with an energy source 306 can be referred to as a discharge circuit for the energy source 306. When releasing energy, LCD 340 can open switches Q1 through Q12.

LCD 340 can also operate switches Q1-Q12 of converters 310-1 through 310-3 and 320 to output and regulate the pulse of electrical energy from energy sources 306-1 through 306-3 by providing switch signals to switches Q1-Q12. The control or switch signals for the embodiments of converters described herein can be generated in different ways depending on the control technique utilized by system power supply system 100 to generate the pulse of energy to load 101. In some embodiments, the control technique is a PWM technique such as space vector pulse-width modulation (SVPWM) or sinusoidal pulse-width modulation (SPWM), or variations thereof. For ease of description, the embodiments herein will be described in the context of a PWM control technique, although the embodiments are not limited to such. Other classes of techniques can be used. One alternative class is based on hysteresis, examples of which are described in Int'l Publ. Nos. WO 2018/231810A1, WO 2018/232403A1, and WO 2019/183553A1, which are incorporated by reference herein for all purposes.

LCD 340 can receive control information from MCD 120. As described above, the control information can include a voltage reference signal that indicates a target voltage level for a pulse of electrical energy output by power supply cell 210, a current reference signal that indicates a target current level for the pulse of energy output by power supply cell 210, and/or a synchronization signal that indicates when LCD 120 is to control its converters 310-1 through 310-3 and 320 to output a pulse of electrical energy.

LCD 340 can control switches Q1-Q6 of boost converters 310-1 through 310-3 to release energy from their energy sources 306-1 through 306-3, respectively, and to regulate the voltage and current on power bus 330. LCD 340 can control switches Q1-Q6 such that each boost converter 310-1 through 310-3 output the same voltage level, e.g., within a tolerance.

LCD 340 can also control switches Q1-Q6 such that each boost converter 310-1 through 310-3 outputs a share of the total current for power bus 330. For example, LCD 340 can also control switches Q1-Q6 such that each boost converter 310-1 through 310-3 outputs about one third of the total current for power bus 330 or different current levels that, when combined, equals the total current for power bus 330.

LCD 340 can determine the target voltage and current levels for power bus 330 based on the voltage and current reference signals of the control information received from MCD 120. In another example embodiment, LCD 340 can control switches Q1-Q6 of boost converters 310-1 through 310-3 regulate the voltage and current of power bus 330 at a specified level independent of the control information and regulate switches Q7-Q12 of buck converter 320 to regulate the output voltage and current at ports IO3 and IO4 based on the control information.

In just one of many possible embodiments for example, a two-level three-phase interleaved buck converter as described with reference to FIG. 3B has ten power supply cells in a cell array 130 that is to output a three second energy pulse, and in this example the switching frequency of buck converter 320 is 100 microseconds. The 100 microsecond period can be divided by 30 (e.g., 3 phases*10 power supply cells), resulting in a 3.33 microsecond shift between the 30 output voltages and currents.

FIG. 3C is schematic diagram of another example embodiment of a power supply cell 210. In this example embodiment, power supply cell 210 includes three-level converters 310-1 through 310-3 and 320 with an intermediate power bus 332 electrically between pairs of switches of converters 310-1 through 310-3 and 320. The intermediate power bus 332 typically carries half the voltage of power bus 330. This enables converters 310-1 through 310-3 and 320 to have lower voltage rated switches Q1-Q10 and Q1′-Q10′ compared to two-level converters the voltage across each pair of switches (e.g., Q1 and Q1′) is half the voltage of power bus 330.

Each boost converter 310-1 through 310-3 is electrically couple to a corresponding energy source 306-1 through 306-3, respectively. Each boost converter 310-1 through 310-3 includes a first pair of switches (Q1 and Q1′ for converter 310-1, Q3 and Q3′ for converter 310-2, and Q5 and Q5′ for converter 310-3) electrically coupled between power bus 330 and intermediate power bus 332, a second pair of switches (Q2 and Q2′ for converter 310-1, Q4 and Q4′ for converter 310-2, and Q6 and Q6′ for converter 310-3) electrically coupled between intermediate power bus 332 and ground 331, and an inductor L_{Bst} electrically coupled between energy source 306 and the first pair of switches. Boost converters 310-1 through 310-3 are electrically coupled between power bus 330 and ground 331 and are electrically coupled in parallel with each other. In this way, boost converters 310-1 through 310-3 share the current load of power bus 330, enabling lower current rated switches Q1-Q6 and Q1′-Q6′ to be used. The three-level arrangement also allows for a smaller inductor L_{Bst} to be used relative to two-level converter embodiments.

LCD 340 can control switches Q1-Q6 and Q1′-Q6′ to regulate the voltage and current of power bus 330 and intermediate power bus 332. For example, LCD 340 can control switches Q1-Q6 and Q1′-Q6′ such that the voltage level of intermediate bus 332 is half the voltage level of power bus 330.

Buck converter 320 is implemented as a three-level, two-phase interleaved converter that includes four pairs of switches Q7 and Q7′, Q8 and Q8′, Q9 and Q9′, and Q10 and Q10′ with four output inductors L_{bk1}-L_{bk4}. LCD 340 can control switches Q7-Q10 and Q7′-Q10′ to regulate the output voltage and current at ports IO3 and IO4. LCD 340 can also control switches Q7, Q7′, Q9, and Q9′ to shift the voltage and/or current output through each inductor L_{bk1} and L_{bk2}. Similarly, LCD 340 can control switches Q8, Q8′, Q10, and Q10′ to shift the voltage and/or current output through each inductor L_{bk3} and L_{bk4}. These phase shifts reduces the ripple current at the output of inductors L_{bk1}-L_{bk4}. In some embodiments, LCD 340 can control switches Q7-Q10 and Q7′-Q10′ such that the phase of the voltage and/or current of inductor L_{bk1} matches the phase of the voltage and/or current, respectively, of inductor L_{bk3}. Similarly, LCD 340 can control switches Q7-Q10 and Q7′-Q10′ such that the phase of the voltage and/or current of inductor L_{bk2} matches the phase of the voltage and/or current, respectively, of inductor L_{bk4}. In this way, the phase shifts reduce the ripple currents on both ports IO3 and IO4.

LCD 340 can operate switches 351-1 through 351-5, switches 352-1 through 352-3, and switches Q2′, Q4′, and Q6′ to selectively charge energy sources 306-1 through 306-3 and to output a pulse of electrical energy from energy sources 306-1 through 306-3. To charge energy sources 306-1 through 306-3, LCD 340 can open switches 352-1 through 352-3 and close switches 351-1 through 351-5 and switches Q2′, Q4′, and Q6′ by providing switch signals to switches 352-1 through 352-3, switches 351-1 through 351-5, and switches Q2′, Q4′, and Q6′. This enables current to flow from charger 105 electrically coupled to ports IO1 and IO2 to energy sources 306-1 through 306-3. When charging energy sources 306-1 through 306-3, LCD 340 can open switches Q1, Q1′, Q2, Q3, Q3′, Q4, Q5, Q5′, Q6, Q7 through Q10, and Q7′ through Q10′.

To release energy from energy sources 306-1 through 306-3, LCD 340 can close switches 352-1 through 352-3 and switches Q2′, Q4′, and Q6′, and open switches 351-1 through 351-5 by providing switch signals to switches 352-1 through 352-3, switches Q2′, Q4′, and Q6′, and switches 351-1 through 351-5. For example, LCD 340 can operate switches 352-1 through 352-3, switches Q2′, Q4′, and Q6′, and switches 351-1 through 351-5 in this manner to release energy from energy sources 306-1 through 306-3 through resistors R_{d} (e.g., dump resistors) when power cell 210 is not in operation or in other conditions in which energy sources 306-1 through 306-3 should not be storing a charge. This prevents energy sources 306-1 through 306-3 from storing residual energy and ensures that power cell 210 is in a safe state when not in operation.

When releasing energy, LCD 340 can open switches Q1, Q1′, Q2, Q3, Q3′, Q4, Q5, Q5′, Q6, Q7 through Q10, and Q7′ through Q10′.

In this embodiment, power supply cell 210 includes a capacitor C_{bus1} electrically coupled between power bus 330 and intermediate bus 332 and a capacitor C_{bus2} electrically coupled between intermediate bus 330 and ground 331. Similar to capacitor C_{bus} of the embodiment of FIG. 3C, capacitors C_{bus1} and C_{bus2} can operate as a filter capacitor for the boost stages that include boost converters 310-1 through 310-3. Capacitors C_{bus1} and C_{bus2} can also provide a buffer to stabilize the DC bus voltage present on power bus 330 whenever there are transients reflected at the input of the buck stage that includes buck converter 320 by the load dynamics at the output of the buck stage.

FIG. 3D is schematic diagram of another example embodiment of a power supply cell 210. The converters 310-1 through 310-3 and 320 of this example embodiment are also implemented as three-level converters. This embodiment differs from the embodiment of FIG. 3C in that this embodiment does not include an intermediate power bus 332. Instead, each boost converter 310-1 through 310-3 includes a flying capacitor C_{fly1}-C_{fly3} electrically coupled between the two pairs of switches of the boost converter 310-1 through 310-3. In addition, each energy source 306-1 through 306-3 is electrically coupled between ground bus 331 and the pairs of switches its boost converter 306-1 through 306-3, respectively. In this example, LCD 340 can control switches Q1-Q6 and Q1′-Q6′ of boost converters 310-1 through 310-3 to regulate the voltage and current of power bus 330.

Buck converter 320, which is also implemented as a three-level, two-phase interleaved buck converter, also includes two flying capacitors C_{fly4} and C_{fly5} that can also be charged to half the voltage of power bus 330 using the pre-charge circuit. In this example, buck converter 320 includes two output inductors L_{bk1} and L_{bk2}. LCD 340 can control switches Q7-Q10 and Q7′-Q10′ to regulate the output voltage and current at ports IO3 and IO4. LCD 340 can also control switches Q7-Q10 and Q7′-Q10′ to shift the voltage and/or current output through each inductor L_{bk1} and L_{bk2} to reduce the ripple current output on port IO3.

The embodiment of power supply cell 210 of FIG. 3D has similar advantages as the embodiment of power supply cell 210 of FIG. 3C. For example, lower rated switches can be used in each converter 310 and 320 due to the voltage across each switch being half the voltage of power bus 330. Lower current rated switches can be used in power converters 310 and 320 due to the parallel boost converters 310-1 through 310-3 enabling current splitting between boos converters 310-1 and 310-3 and due to the two-phase output of buck converter 320 enabling current splitting between the two branches of switches (e.g., one branch with switches Q7, Q7′, Q8, and Q8′ and another branch with Q9, Q9′, Q10, and Q10′) of buck converter 320. The reduced ripple currents enable smaller inductors L_{bk1} and L_{bk2} and output filter capacitor C_{f}. The size of output inductors L_{bk1} and L_{bk2} (and L_{bk3} and L_{bk4} of FIG. 3C) can be further reduced since the three-level converters cause these indictors L_{bk} are subjected to twice the switching frequency of switches Q7-Q10 and Q7′-Q10′, whereas inductors of a two-level converter are subjected to the switching frequency. The higher frequency enables a smaller filter inductor at the output of buck converter 320.

LCD 340 can operate switches 351-1 through 351-5 and 352-1 through 352-3 to selectively charge energy sources 306-1 through 306-3 and to output a pulse of electrical energy from energy sources 306-1 through 306-3. Switches 351-1 through 351-5 and 352-1 through 352-3 can be any suitable switch type, such as mechanical switches or power semiconductors, e.g., IGBTs, MOSFETs, or GaN transistors.

To charge energy sources 306-1 through 306-3, LCD 340 can open switches 352-1 through 352-3 and close switches 351-1 through 351-5 by providing switch signals to switches 352-1 through 352-3 and 351-1 through 351-5. This enables current to flow from charger 105 electrically coupled to ports IO1 and IO2 to energy sources 306-1 through 306-3. When charging energy sources 306-1 through 306-3, LCD 340 can open switches Q1 through Q10 and Q1′ through Q10′.

To release energy from energy sources 306-1 through 306-3, LCD 340 can close switches 352-1 through 352-3 and open switches 351-1 through 351-5 by providing switch signals to switches 352-1 through 352-3 and 351-1 through 351-5. For example, LCD 340 can operate switches 352-1 through 352-3 and 351-1 through 351-5 in this manner to release energy from energy sources 306-1 through 306-3 through resistors Ra (e.g., dump resistors) when power cell 210 is not in operation or in other conditions in which energy sources 306-1 through 306-3 should not be storing a charge. This prevents energy sources 306-1 through 306-3 from storing residual energy and ensures that power cell 210 is in a safe state when not in operation. When releasing energy, LCD 340 can open switches Q1 through Q10 and Q1′ through Q10′ In this embodiment, power supply cell 210 includes a capacitor C_{bus} electrically coupled between power bus 330 and ground 331. Capacitor C_{bus} can operate as a filter capacitor for the boost stages that include boost converters 310-1 through 310-3. For example, capacitor C_{bus} can filter the DC bus voltage on power bus 330. Capacitor C_{bus} can also provide a buffer to stabilize the DC bus voltage present on power bus 330 whenever there are transients reflected at the input of the buck stage that includes buck converter 320 by the load dynamics at the output of the buck stage.

A pre-charge circuit can be used to charge each flying capacitor C_{fly1}-C_{fly3} to half the voltage of power bus 330 before operation of boost converters 310-1 through 310-3. In some embodiments, LCD 340 can control switches Q1 through Q6 and Q1′ through Q6′ to pre-charge flying capacitors C_{fly1}-C_{fly3} to half the voltage of power bus 330 before operation of boost converters 310-1 through 310-3. In embodiments in which switches Q1, Q3, and Q5 have a body diode, LCD 340 can open switches Q1-Q6, Q1′, Q3′, and Q5′ and close switches Q2′, Q4′, and Q6′ during charging of energy sources 306-1 through 306-3, This enables current to flow through the body diodes of each switch Q1, Q3, and Q5 to its corresponding flying capacitor C_{fly1}-C_{fly3}, respectively. If switches Q1, Q3, and Q5 do not have a body diode, LCD 340 can close switches Q1, Q3, and Q5 to pre-charge flying capacitors C_{fly1}-C_{fly3}. LCD 340 can monitor the voltage across each flying capacitor C_{fly1}-C_{fly3} and open switch Q2′, Q4′, Q6′, e.g., using voltage sensors. When the voltage across a flying capacitor reaches the target pre-charge voltage, e.g., half the voltage of power bus 330, LCD 340 can open switch Q2′, Q4′, or Q6′ for that flying capacitor. For example, when the voltage across flying capacitor C_{fly} reaches the target pre-charge voltage, LCD 340 can open switch Q2′ to stop charging flying capacitor C_{fly1}.

FIG. 4A is a schematic diagram of an example embodiment of a cell array 130. In this example embodiment, cell array 130 includes a number “N” of power supply cells 210 implemented using the embodiment shown in FIG. 3B and described above. Power supply cells 210 are electrically coupled in cascade such that the output energy of each power supply cell 210 is combined at the output between ports IO3 and IO4 of cell array 130. Charging bus 220 electrically couples ports IO1 and 102 of cell array 130 to each power supply cell 210-1 through 210-N to charge energy sources 306-1 through 306-3 of each power supply cell 210-1 through 210-N.

As described above MCD 120 can provide control information to LCD 340 of each power supply cell 210-1 through 210-N. MCD 120 can provide control information to each LCD 340 to regulate the voltage and current at ports IO3 and IO4. In some situations, the target voltage level between ports IO3 and IO4 may be substantially less than the combined voltage level than power supply cells 210 can generate. In such situations, MCD 120 can bypass one or more power supply cells 210 by instructing LCD 340 via the control information to not output energy. LCD 340 can operate its crowbar switch Q_{cb}, e.g., by closing crowbar switch Q_{cb}, to provide a path for current to flow through the output of bypassed power cell 210.

In addition, as described above, crowbar switches Q_{cb} provide short circuit protection. If a short circuit if detected at load 101, SCD 102 can instruct MCD 120 to close all crowbar switches Q_{cb} of its cell array 130. In turn, MCD 120 can instruct LCD 340 of each power supply 210 of its cell array 130 to close its crowbar switch Q_{cb}. This enables the filter capacitor at the output of each power supply cell 210 to discharge through crowbar switch Q_{cb} rather than to load 101, thereby isolating and bypassing converters 310 and 320.

FIG. 4B is a schematic diagram of an example embodiment of a cell array 130 that includes a number “N” of power supply cells 210. In this example, each power supply cell 210 is implemented using the embodiment shown in FIG. 3C and described above. Power supply cells 210 are electrically coupled in cascade such that the output energy of each power supply cell 210 is combined at the output between ports IO3 and IO4 of cell array 130.

FIG. 4C is a schematic diagram of an example embodiment of a cell array 130 that includes a number “N” of power supply cells 210. In this example, each power supply cell 210 is implemented using the embodiment shown in FIG. 3D and described above. Power supply cells 210 are electrically coupled in cascade such that the output energy of each power supply cell 210 is combined at the output between ports IO3 and IO4 of cell array 130.

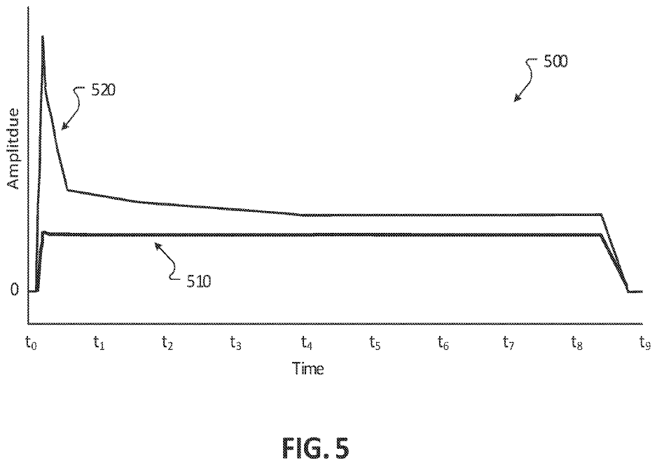

FIG. 5 is a plot 500 depicting example output voltage 510 and output current 520 of a power supply cell 210. As described above, each power supply cell 210 can be operated to output a pulse of electrical energy lasting a specified duration. As shown in FIG. 5, the output voltage 510 is regulated to remain constant throughout the pulse duration, with some time to ramp up and ramp down. The output current 520 of a power cell 210 spikes at the beginning of an energy pulse and falls to a relatively constant value for the remaining duration of the energy pulse.

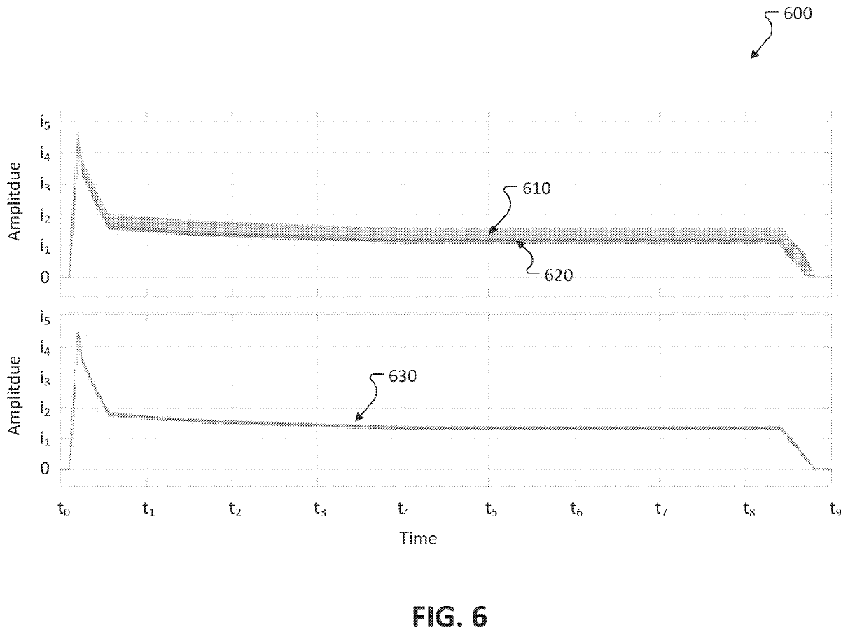

FIG. 6 is a plot 600 depicting example inductor currents of a power supply cell. In particular, the plot 600 depicts current 620 of inductor L_{bk1}, current 610 of inductor L_{bk2}, and a combined current 630 at the output of power supply cell 210 of FIG. 3. As depicted in plot 600, there is a larger ripple in currents 610 and 620 throughout the duration of a pulse of energy being output by power supply cell 210 than the ripple in the combined current 630.

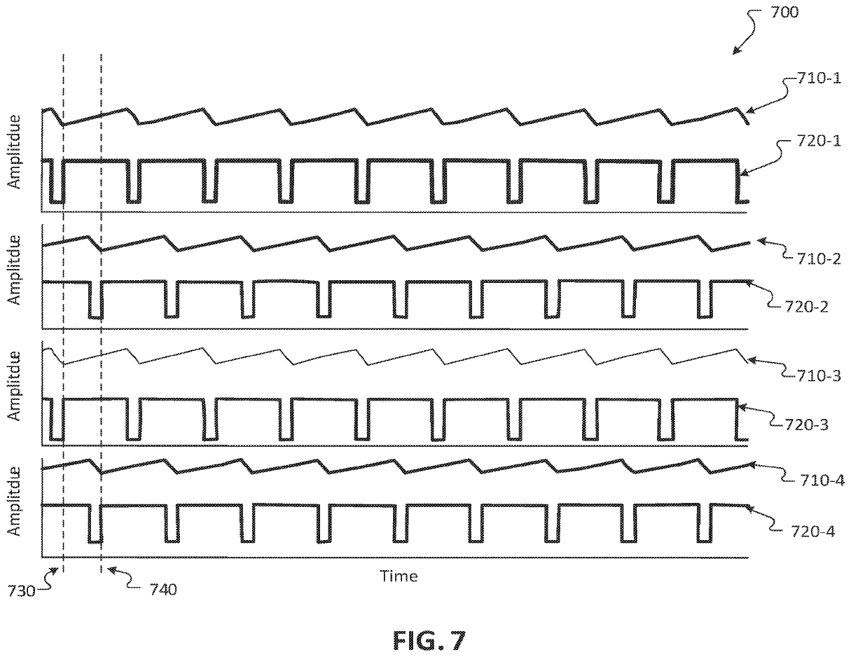

FIG. 7 is a plot 700 depicting example inductor voltages 720-1 through 720-4 and inductor currents 710-1 through 710-4 of inductors of a buck converter 320 of a power supply cell 210. In particular, the plot 700 depicts example inductor voltages 720-1 through 720-4 and inductor currents 710-1 through 710-4 of buck converter 320 of power supply cell 210 of FIG. 3C when power supply cell 210 it outputting a pulse of electrical energy. As depicted in plot 700, the current 710-1 through 710-4 flowing through each inductor L_{bk1}-L_{bk4}, respectively, is in the form of a triangular waveform and the voltage 730-1 through 710-4 flowing through each inductor L_{bk1}-L_{bk4}, respectively, is in the form of a square waveform. In addition, lines 730 and 740 of plot 700 show the phase shift between the voltage 720-1 and current 710-1 of inductor L_{bk1} and the voltage 720-2 and current 710-2 of inductor L_{bk2}. These lines 730 and 740 also show the phase shift between the voltage 720-3 and current 710-3 of inductor L_{bk3} and the voltage 720-4 and current 710-4 of inductor L_{bk3}. These lines 730 and 740 also show that the voltage 720-1 and current 710-1 of inductor L_{bk1} are in phase with the voltage 720-3 and current 710-3 of inductor L_{bk3}, and that the voltage 720-2 and current 710-2 of inductor L_{bk2} are in phase with the voltage 720-4 and current 710-4 of inductor L_{bk4}.

In some embodiments, the voltages and currents of inductors L_{bk1} and L_{bk2} of power supply cell 210 illustrated in FIG. 3D are the same as or similar to those of inductors L_{bk1} and L_{bk2} of power supply cell 210 illustrated in FIG. 3C. Similarly, the voltages and currents of inductors L_{bk1}-L_{bk3} of power supply cell 210 illustrated in FIG. 3B can be the same as or similar to those of inductors L_{bk1}-L_{bk3} of power supply cell 210 illustrated in FIG. 3C. The voltages and currents of inductors L_{bk1}-L_{bk3} of power supply cell 210 illustrated in FIG. 3B can be shifted 120 degrees.

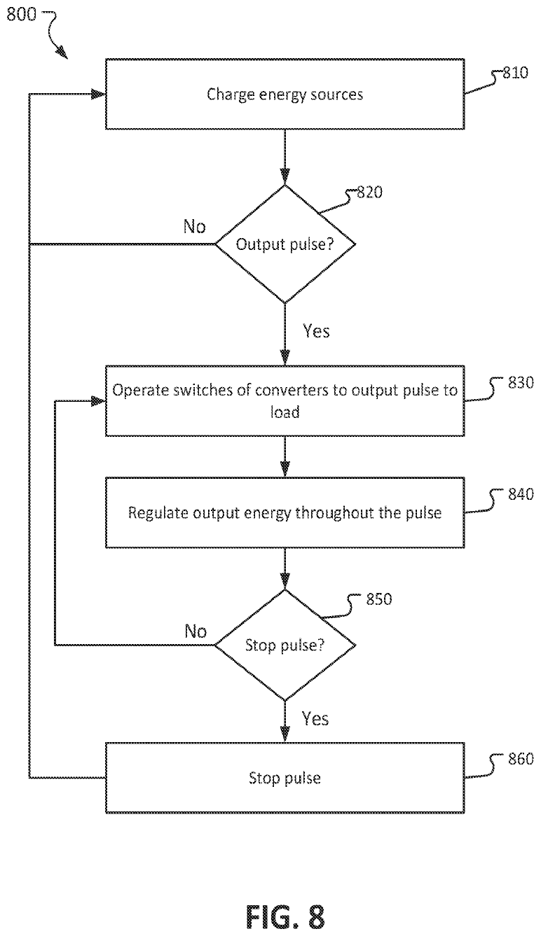

FIG. 8 is a flow diagram depicting an example embodiment of a method 800 of providing pulsed power to a load. Method 800 can be performed by any embodiment of power supply system 100 described herein.

At step 810, energy sources 306 are charged. Each boost converter 310 of each power supply cell 210 of power supply system 100 can be electrically coupled to an energy source 306 and LCD 340 can operate switches of each boost converter 310 to release energy from its energy source 306 and convert electrical energy released by energy source 306 to a target voltage and current for a power bus of power supply cell 210.

To store energy in energy source, SCD 102 can send control signals over communication paths or links 107 to MCDs 120 of power supply units 110. These control signals can instruct MCDs 120 to place power supply cells 210 of its power supply unit 110 into a charging mode where energy sources 306 of each power supply cell 210 are charged. In turn, LCD 120 can send control information over communication path or links 108 to instruct each LCD 340 to place its power supply cell 210 into the charging mode. In turn, LCD 340 can send switch signals to one or more switches to enable electrical energy from a charger 105 to charge each energy source 306 of its power supply cell 210. SCD 102 can also send control signals over communication paths or links 106 to chargers 105 instructing chargers 105 to output electrical energy to cell arrays 130 to charge energy sources 306.

At step 820, a determination is made whether to output a pulse of electrical energy. In some embodiments, power supply system 100 can be configured to output a pulse of electrical energy to load 101 in response to receiving an instruction from an external device, e.g., a controller of load 101. In this embodiment, SCD 102 can determine to output a pulse of electrical energy in response to receiving the instruction. In some embodiments, power supply system 100 can be configured to output a pulse of electrical energy periodically to load 101. In this embodiment, SCD 102 can determine to output a pulse of electrical energy based on a specified time period, e.g., each time the specified time period lapses.

If SCD 102 determines to not output a pulse of electrical energy, SCD 102 can maintain the charging mode, e.g., until each energy source 306 is fully charged. If SCD 102 determines to output a pulse of electrical energy, SCD can send control signals to MCD 120 to instruct MCD 120 to control power supply cells 210 in its cell array 130 to output a pulse of energy. As described above, the control signals can include a synchronization signal that indicates when MCD 120 is to control its cell array 210 to output a pulse of electrical energy, a voltage reference signal that indicates a target voltage level for the pulse of electrical energy to be output by power supply unit 110 that includes MCD 120, a current reference signal that indicates a target current level for the pulse of energy output by power supply unit 110 that includes MCD 120, and/or a duration of the pulse of electrical energy.

In response to receiving the control signals, MCD 120 can generate and send control information to LCDs 340 of its cell array to instruct LCDs 340 to control their converters 310 and 320 to output the pulse of electrical energy. As described above, this control information can include a voltage reference signal that indicates a target voltage level for a pulse of electrical energy output by power supply cell 210 that includes LCD 340, a current reference signal that indicates a target current level for the pulse of energy output by power supply cell 210 that includes LCD 340, and/or a synchronization signal that indicates when LCD 120 is to control its converters 310-1 through 310-3 and 320 to output a pulse of electrical energy.

As described above, MCD 120 can cause each power supply cell 210 of its cell array 130 to output a phase-shifted voltage and current relative to each other power supply unit 210 of its cell array 130 to reduce ripple currents at the output of power supply unit 110. In addition, each power supply cell 210 can include a multi-phase interleaved buck converter that outputs phase-shifted voltages and/or currents. MCD 120 can determine and provide, as part of the control information, the phase for each power supply cell 210 and/or each phase of buck converter 320 of each power supply cell 210.

At step 830, each LCD 340 operates switches of converters 310 and 320 of its power supply cell 210 to output a pulse of electrical energy based on the received control information. As described above, LCD 340 can use PWM or other techniques to generate switching signals for each converter 310 and 320 based on the control information and send the switching signals to the switches of converters 310 and 320.

At step 840 each LCD 840 regulates the output energy throughout the duration that the pulse of energy is output to load 101. LCD 340 can operate switches of buck converter 320 of its power supply cell 210 to regulate the voltage and/or current output by its power supply cell 210

At step 850, a determination is made whether to stop providing the pulse of electrical energy. In general, each pule of electrical energy can be for a specified duration. Each MCD 120 or LCD 340 can determine to stop providing the pulse of electrical energy in response to the duration lapsing.

At step 860, the pulse of energy is stopped. If MCD 120 makes the determination to stop the pulse of electrical energy, MCD 120 can send control information to each LCD 340 of its power supply unit 110 to instruct each LCD 340 to stop outputting electrical energy to load 101. LCD 340 can operate switches of converters 310 and 320 to stop outputting electrical energy to load 101.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated or taught otherwise.

In many embodiments, a power supply system configured to provide pulsed power to a load includes a plurality of power supply units that each include an array of cascaded power supply cells. Each power supply cell includes a plurality of energy sources; a plurality of boost converters electrically coupled in parallel, each boost converter being configured to convert electrical energy from at least one of the energy sources and output the converted electrical energy to a power bus; and a buck converter configured to convert electrical energy of the power bus and regulate output voltage and/or output current of the power cell.

In some embodiments, the power supply units are electrically coupled in a cascade arrangement.

In some embodiments, each energy source includes one or more ultracapacitors or one or more supercapacitors.

In some embodiments, each power supply unit includes a main control device and each power supply cell includes a local control device.

In some embodiments, the local control device of each power supply cell of each power supply unit is configured to operate switches of the plurality of boost converters of the power supply cell and switches of the buck converter of the power supply cell based on control information received from the main control device of the power supply unit.

In some embodiments, the control information includes at least one of a reference voltage, a reference current, a pulse duration, or a phase angle for the power supply cell.

In some embodiments, the power supply system includes a supervisory control device communicably coupled to each main control device. Each main control device can be configured to generate and send the control information to each local control device based on control signals received from the supervisory control device.

In some embodiments, the supervisory control device is communicably coupled to one or more chargers configured to charge the plurality of energy sources of each power supply cell of each power supply unit. The supervisory control device is configured to instruct the one or more chargers to charge the plurality of energy sources of each power supply cell between each pulse of electrical energy output by the power supply system.

In some embodiments, each power supply cell includes a crowbar switch electrically coupled between output ports of the power supply cell.

In some embodiments, each crowbar switch is electrically coupled in parallel with a filter capacitor electrically coupled between the output ports.

In some embodiments, the power supply system includes one or more control devices configured to operate each crowbar switch to isolate the plurality of boost converters and the buck converter of each power supply cell in response to detecting a short circuit condition.

In some embodiments, each boost converter includes a two-level boost converter and each buck converter includes a two-level buck converter.

In some embodiments, each buck converter includes a multi-phase interleaved buck converter.

In some embodiments, each boost converter includes a three-level boost converter and each buck converter includes a three-level buck converter.

In some embodiments, each buck converter includes a multi-phase interleaved buck converter.

In some embodiments, the power supply system includes an intermediate bus and a ground bus.

In some embodiments, each boost converter includes a first set of switches electrically coupled between the power bus and the intermediate bus and a second set of switches electrically coupled between the intermediate bus and the ground bus.

In some embodiments, the power supply system includes a first capacitor electrically coupled between the power bus and the intermediate bus and a second capacitor electrically coupled between the intermediate bus and the ground bus.

In some embodiments, the buck converter includes a first pair of switches electrically coupled between the power bus and the intermediate bus; a second pair of switches electrically coupled between the power bus and the intermediate bus; a third pair of switches electrically coupled between the intermediate bus and the ground bus; and a fourth pair of switches electrically coupled between the intermediate bus and the ground bus.

In some embodiments, the power supply system includes a first inductor electrically coupled between a first node between the first pair of switches and a first polarity output bus that is electrically coupled to the load; a second inductor electrically coupled between a second node between the second pair of switches and the first polarity output bus; a third inductor electrically coupled between a third node between the third pair of switches and a second polarity output bus that is electrically coupled to the load; and a fourth inductor electrically coupled between a fourth node between the fourth pair of switches and the second polarity output bus.

In some embodiments, a first current of the first inductor is phase shifted relative to a second current of the second inductor and a third current of the third inductor is phase shifted relative to a fourth current of the fourth inductor.

In some embodiments, each boost converter includes four switches electrically coupled between the power bus and a ground bus.

In some embodiments, each boost converter includes a first pair of switches, a second pair of switches, and a flying capacitor electrically coupled between a node between the first pair of switches and a node between the second pair of switches.

In some embodiments, the power supply system includes a pre-charging circuit for pre-charging each flying capacitor.

In some embodiments, the power supply system includes a control system configured to pre-charge each flying capacitor by closing a switch of each boost converter when charging each energy source.

In some embodiments, the buck converter includes a first branch of switches electrically coupled between the power bus and the ground bus, the first branch of switches comprising a first pair of switches and a second pair of switches and a second branch of switches electrically coupled between the power bus and the ground bus, the second branch of switches comprising a third pair of switches and a fourth pair of switches.

In some embodiments, the power supply system includes a first flying capacitor electrically coupled between a first node between the first pair of switches and a second node between the second pair of switches and a second flying capacitor electrically coupled between a third node between the third pair of switches and a fourth node between the fourth pair of switches.

In some embodiments, the buck converter includes a first inductor electrically coupled between (i) a fifth node between the first pair of switches and the second pair of switches and (ii) a first polarity output bus that is electrically coupled to the load; and a second inductor electrically coupled between (i) a sixth node between the third pair of switches and the fourth pair of switches and (ii) the first polarity output bus that is electrically coupled to the load.

In some embodiments, a first current of the first inductor is phase shifted relative to a second current of the second inductor.

In some embodiments, the power supply system includes a terminal between each pair of power supply units.

In some embodiments, each terminal is electrically coupled to the load.

In some embodiments, the power supply system includes a charge circuit for each energy source.

In some embodiments, each charge circuit includes one more switches for selectively electrically coupling the energy source to a charger.

In some embodiments, the power supply system includes a discharge circuit for each energy source, each discharge circuit comprising a discharge switch and a dump resistor for discharging the energy source.

In many embodiments, a power supply unit includes a plurality of power supply cells. Each power supply cell includes a plurality of energy sources; a plurality of first converters electrically coupled in parallel, each first converter being configured to convert electrical energy from at least one of the energy sources and output the converted electrical energy to a power bus; and a second converter configured to convert electrical energy of the power bus and regulate output voltage and/or output current of the power cell.

In some embodiments, each energy source includes one or more ultracapacitors or one or more supercapacitors.

In some embodiments, the power supply unit includes a main control device, wherein each power supply cell comprises a local control device.

In some embodiments, the local control device of each power supply cell is configured to operate switches of the plurality of first converters and switches of the second converter based on control information received from the main control device.

In some embodiments, the control information includes at least one of a reference voltage, a reference current, a pulse duration, or a phase angle for the power supply cell.

In some embodiments, the main control device is configured to generate and send the control information to each local control device based on control signals received from a supervisory control device.

In some embodiments, the supervisory control device is communicably coupled to one or more chargers configured to charge the plurality of energy sources of each power supply cell, and the supervisory control device is configured to instruct the one or more chargers to charge the plurality of energy sources of each power supply cell between each pulse of electrical energy output by the power supply system.

In some embodiments, each power supply cell includes a crowbar switch electrically coupled between output ports of the power supply cell.

In some embodiments, each crowbar switch is electrically coupled in parallel with a filter capacitor electrically coupled between the output ports.

In some embodiments, the power supply unit includes one or more control devices configured to operate each crowbar switch to isolate the plurality of first converters and the second converter of each power supply cell in response to detecting a short circuit condition.

In some embodiments, each first converter includes a two-level boost converter and each second converter includes a two-level buck converter.

In some embodiments, each buck converter includes a multi-phase interleaved buck converter.

In some embodiments, each first converter includes a three-level boost converter and the second converter includes a three-level buck converter.

In some embodiments, each buck converter includes a multi-phase interleaved buck converter.

In some embodiments, the power supply unit includes an intermediate bus and a ground bus.

In some embodiments, each boost converter includes a first set of switches electrically coupled between the power bus and the intermediate bus and a second set of switches electrically coupled between the intermediate bus and the ground bus.

In some embodiments, the power supply unit includes a first capacitor electrically coupled between the power bus and the intermediate bus and a second capacitor electrically coupled between the intermediate bus and the ground bus.

In some embodiments, the buck converter includes a first pair of switches electrically coupled between the power bus and the intermediate bus; a second pair of switches electrically coupled between the power bus and the intermediate bus; a third pair of switches electrically coupled between the intermediate bus and the ground bus; and a fourth pair of switches electrically coupled between the intermediate bus and the ground bus.

In some embodiments, the power supply unit includes a first inductor electrically coupled between a first node between the first pair of switches and a first polarity output bus that is electrically coupled to the load; a second inductor electrically coupled between a second node between the second pair of switches and the first polarity output bus; a third inductor electrically coupled between a third node between the third pair of switches and a second polarity output bus that is electrically coupled to the load; and a fourth inductor electrically coupled between a fourth node between the fourth pair of switches and the second polarity output bus.

In some embodiments, a first current of the first inductor is phase shifted relative to a second current of the second inductor and a third current of the third inductor is phase shifted relative to a fourth current of the fourth inductor.

In some embodiments, each boost converter includes four switches electrically coupled between the power bus and a ground bus.

In some embodiments, each boost converter includes a first pair of switches, a second pair of switches, and a flying capacitor electrically coupled between a node between the first pair of switches and a node between the second pair of switches.

In some embodiments, the power supply unit includes a pre-charging circuit for pre-charging each flying capacitor.

In some embodiments, the power supply unit includes a control system configured to pre-charge each flying capacitor by closing a switch of each boost converter when charging each energy source.

In some embodiments, the buck converter includes a first branch of switches electrically coupled between the power bus and the ground bus, the first branch of switches comprising a first pair of switches and a second pair of switches; and a second branch of switches electrically coupled between the power bus and the ground bus, the second branch of switches comprising a third pair of switches and a fourth pair of switches.

In some embodiments, the power supply unit includes a first flying capacitor electrically coupled between a first node between the first pair of switches and a second node between the second pair of switches and a second flying capacitor electrically coupled between a third node between the third pair of switches and a fourth node between the fourth pair of switches.

In some embodiments, the buck converter includes a first inductor electrically coupled between (i) a fifth node between the first pair of switches and the second pair of switches and (ii) a first polarity output bus that is electrically coupled to the load and a second inductor electrically coupled between (i) a sixth node between the third pair of switches and the fourth pair of switches and (ii) the first polarity output bus that is electrically coupled to the load.

In some embodiments, a first current of the first inductor is phase shifted relative to a second current of the second inductor.

In some embodiments, the power supply unit includes a terminal between each pair of power supply units.

In some embodiments, each terminal is electrically coupled to the load.

In some embodiments, the power supply unit includes a charge circuit for each energy source.

In some embodiments, each charge circuit includes one more switches for selectively electrically coupling the energy source to a charger.

In some embodiments, the power supply unit includes a discharge circuit for each energy source. Each discharge circuit can include a discharge switch and a dump resistor for discharging the energy source.

In many embodiments, a power supply unit includes a plurality of energy sources; a plurality of boost converters electrically coupled in parallel, each boost converter being configured to convert electrical energy from at least one of the energy sources and output the converted electrical energy to a power bus; and a buck converter configured to convert electrical energy of the power bus and regulate output voltage and/or output current of the power cell.

In many embodiments, a method of providing pulsed power to a load includes charging energy sources of first converters of each of multiple power cells; operating switches of the first converters of each power cell to generate an output pulse of energy for the load; and operating switches of a second converter of each power cell to regulate the output pulse of energy for the load.

In some embodiments, each first converter includes a boost converter and each second converter comprises a buck converter.

In some embodiments, each power cell is configured in accordance with any of the aforementioned embodiments.

In some embodiments, operating the switches of the first converter and switches of the second converter comprises operating the switches for a specified duration of the pulse of energy.

In some embodiments, the method includes recharging the energy sources of the first converters of each power cell after the specified duration elapses.

The term “module” as used herein refers to one of two or more devices or sub-systems within a larger system. The module can be configured to work in conjunction with other modules of similar size, function, and physical arrangement (e.g., location of electrical terminals, connectors, etc.). Modules having the same function and energy source(s) can be configured identical (e.g., size and physical arrangement) to all other modules within the same system (e.g., rack or pack), while modules having different functions or energy source(s) may vary in size and physical arrangement. While each module may be physically removable and replaceable with respect to the other modules of the system (e.g., like wheels on a car, or blades in an information technology (IT) blade server), such is not required. For example, a system may be packaged in a common housing that does not permit removal and replacement any one module, without disassembly of the system as a whole. However, any and all embodiments herein can be configured such that each module is removable and replaceable with respect to the other modules in a convenient fashion, such as without disassembly of the system.

The term “output” is used herein in a broad sense, and does not preclude functioning in a bidirectional manner as both an output and an input. Similarly, the term “input” is used herein in a broad sense, and does not preclude functioning in a bidirectional manner as both an input and an output.

The terms “terminal” and “port” are used herein in a broad sense, can be either unidirectional or bidirectional, can be an input or an output, and do not require a specific physical or mechanical structure, such as a female or male configuration.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated otherwise or logically implausible.

Processing circuitry can include one or more processors, microprocessors, hardware controllers, and/or microcontrollers, each of which can be a discrete or stand-alone chip or distributed amongst (and a portion of) a number of different chips. Any type of processing circuitry can be implemented, such as, but not limited to, personal computing architectures (e.g., such as used in desktop PC's, laptops, tablets, etc.), programmable gate array architectures, proprietary architectures, custom architectures, and others. Processing circuitry can include a digital signal processor, which can be implemented in hardware and/or software. Processing circuitry can execute software instructions stored on memory that cause processing circuitry to take a host of different actions and control other components.

Processing circuitry can also perform other software and/or hardware routines. For example, processing circuitry can interface with communication circuitry and perform analog-to-digital conversions, encoding and decoding, other digital signal processing, multimedia functions, conversion of data into a format (e.g., in-phase and quadrature) suitable for provision to communication circuitry, and/or can cause communication circuitry to transmit the data (wired or wirelessly).

Processing circuitry can also be adapted to execute the operating system and any software applications, and perform those other functions not related to the processing of communications transmitted and received.

Computer program instructions for carrying out operations in accordance with the described subject matter may be written in any combination of one or more programming languages, including computer and programming languages. A non-exhaustive list of examples includes hardware description languages (HDLs), SystemC, C, C++, C#, Objective-C, Matlab, Simulink, System Verilog, System VHDL, Handel-C, Python, Java, JavaScript, Ruby, HTML, Smalltalk, Transact-SQL, XML, PHP, Golang (Go), “R” language, and Swift, to name a few.

Memory, storage, and/or computer readable media can be shared by one or more of the various functional units present, or can be distributed amongst two or more of them (e.g., as separate memories present within different chips). Memory can also reside in a separate chip of its own.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory. The terms “non-transitory” and “tangible” as used herein, are intended to describe memory, storage, and/or computer readable media excluding propagating electromagnetic signals, but are not intended to limit the type of memory, storage, and/or computer readable media in terms of the persistency of storage or otherwise. For example, “non-transitory” and/or “tangible” memory, storage, and/or computer readable media encompasses volatile and non-volatile media such as random access media (e.g., RAM, SRAM, DRAM, FRAM, etc.), read-only media (e.g., ROM, PROM, EPROM, EEPROM, flash, etc.) and combinations thereof (e.g., hybrid RAM and ROM, NVRAM, etc.) and variants thereof.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

As used herein and in the appended claims, the singular forms “a,” “an,” and “the” include plural referents unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A power supply system configured to provide pulsed power to a load, the power supply system comprising:
a plurality of power supply units that each include an array of cascaded power supply cells, each power supply cell comprising,
a plurality of energy sources;
a plurality of boost converters electrically coupled in parallel, each boost converter being configured to convert electrical energy from at least one of the energy sources and output the converted electrical energy to a power bus; and
a buck converter configured to convert electrical energy of the power bus and regulate output voltage and/or output current of the power cell.

2. The power supply system of claim 1, wherein the power supply units are electrically coupled in a cascade arrangement.

3. The power supply system of claim 1 or claim 2, wherein each energy source comprises one or more ultracapacitors or one or more supercapacitors.

4. The power supply system of any preceding claim, wherein each power supply unit comprises a main control device and each power supply cell comprises a local control device.

5. The power supply system of claim 5, wherein the local control device of each power supply cell of each power supply unit is configured to operate switches of the plurality of boost converters of the power supply cell and switches of the buck converter of the power supply cell based on control information received from the main control device of the power supply unit.

6. The power supply system of claim 5, wherein the control information comprises at least one of a reference voltage, a reference current, a pulse duration, or a phase angle for the power supply cell.

7. The power supply system of any of claims 4 to 6, further comprising a supervisory control device communicably coupled to each main control device, wherein each main control device is configured to generate and send the control information to each local control device based on control signals received from the supervisory control device.

8. The power supply system of claim 7, wherein the supervisory control device is communicably coupled to one or more chargers configured to charge the plurality of energy sources of each power supply cell of each power supply unit, and wherein the supervisory control device is configured to instruct the one or more chargers to charge the plurality of energy sources of each power supply cell between each pulse of electrical energy output by the power supply system.

9. The power supply system of any preceding claim, wherein each power supply cell comprises a crowbar switch electrically coupled between output ports of the power supply cell.

10. The power supply system of claim 9, wherein each crowbar switch is electrically coupled in parallel with a filter capacitor electrically coupled between the output ports.

11. The power supply system of claim 9 or claim 10, further comprising one or more control devices configured to operate each crowbar switch to isolate the plurality of boost converters and the buck converter of each power supply cell in response to detecting a short circuit condition.

12. The power supply system of any preceding claim, wherein each boost converter comprises a two-level boost converter and each buck converter comprises a two-level buck converter.

13. The power supply system of claim 12, wherein each buck converter comprises a multi-phase interleaved buck converter.

14. The power supply system of any of claims 1 to 11, wherein each boost converter comprises a three-level boost converter and each buck converter comprises a three-level buck converter.

15. The power supply system of claim 14, wherein each buck converter comprises a multi-phase interleaved buck converter.

16. The power supply system of any one of claims 14 or 15, further comprising an intermediate bus and a ground bus.

17. The power supply system of claim 16, wherein each boost converter comprises a first set of switches electrically coupled between the power bus and the intermediate bus and a second set of switches electrically coupled between the intermediate bus and the ground bus.

18. The power supply system of claim 17, further comprising a first capacitor electrically coupled between the power bus and the intermediate bus and a second capacitor electrically coupled between the intermediate bus and the ground bus.

19. The power supply system of any one of claims 16 to 18, wherein the buck converter comprises:
a first pair of switches electrically coupled between the power bus and the intermediate bus;
a second pair of switches electrically coupled between the power bus and the intermediate bus;
a third pair of switches electrically coupled between the intermediate bus and the ground bus; and
a fourth pair of switches electrically coupled between the intermediate bus and the ground bus.

20. The power supply system of claim 19, further comprising:
a first inductor electrically coupled between a first node between the first pair of switches and a first polarity output bus that is electrically coupled to the load;
a second inductor electrically coupled between a second node between the second pair of switches and the first polarity output bus;
a third inductor electrically coupled between a third node between the third pair of switches and a second polarity output bus that is electrically coupled to the load; and
a fourth inductor electrically coupled between a fourth node between the fourth pair of switches and the second polarity output bus.

21. The power supply system of claim 20, wherein a first current of the first inductor is phase shifted relative to a second current of the second inductor and a third current of the third inductor is phase shifted relative to a fourth current of the fourth inductor.

22. The power supply system of any one of claims 14 or 15, wherein each boost converter comprises four switches electrically coupled between the power bus and a ground bus.

23. The power supply system of any one of claims 14 or 15, wherein each boost converter comprises a first pair of switches, a second pair of switches, and a flying capacitor electrically coupled between a node between the first pair of switches and a node between the second pair of switches.

24. The power supply system of claim 23, further comprising a pre-charging circuit for pre-charging each flying capacitor.

25. The power supply system of claim 23, further comprising a control system configured to pre-charge each flying capacitor by closing a switch of each boost converter when charging each energy source.

26. The power supply system of claim 22, wherein the buck converter comprises:
a first branch of switches electrically coupled between the power bus and the ground bus, the first branch of switches comprising a first pair of switches and a second pair of switches; and
a second branch of switches electrically coupled between the power bus and the ground bus, the second branch of switches comprising a third pair of switches and a fourth pair of switches.

27. The power supply system of claim 26, further comprising:
a first flying capacitor electrically coupled between a first node between the first pair of switches and a second node between the second pair of switches; and
a second flying capacitor electrically coupled between a third node between the third pair of switches and a fourth node between the fourth pair of switches.

28. The power supply system of any one of claims 26 or 27, wherein the buck converter comprises:
a first inductor electrically coupled between (i) a fifth node between the first pair of switches and the second pair of switches and (ii) a first polarity output bus that is electrically coupled to the load; and
a second inductor electrically coupled between (i) a sixth node between the third pair of switches and the fourth pair of switches and (ii) the first polarity output bus that is electrically coupled to the load.

29. The power supply system of claim 28, wherein a first current of the first inductor is phase shifted relative to a second current of the second inductor.

30. The power supply system of any preceding claim, further comprising a terminal between each pair of power supply units.

31. The power supply system of claim 30, wherein each terminal is electrically coupled to the load.

32. The power supply system of any preceding claim, further comprising a charge circuit for each energy source.

33. The power supply system of claim 32, wherein each charge circuit comprises one more switches for selectively electrically coupling the energy source to a charger.

34. The power supply system of any preceding claim, further comprising a discharge circuit for each energy source, each discharge circuit comprising a discharge switch and a dump resistor for discharging the energy source.

35. A power supply unit, comprising:
a plurality of power supply cells, each power supply cell comprising,
a plurality of energy sources;
a plurality of first converters electrically coupled in parallel, each first converter being configured to convert electrical energy from at least one of the energy sources and output the converted electrical energy to a power bus; and
a second converter configured to convert electrical energy of the power bus and regulate output voltage and/or output current of the power cell.

36. The power supply unit of claim 35, wherein each energy source comprises one or more ultracapacitors or one or more supercapacitors.

37. The power supply unit of any one of claim 35 or 36, further comprising a main control device, wherein each power supply cell comprises a local control device.

38. The power supply unit of claim 37, wherein the local control device of each power supply cell is configured to operate switches of the plurality of first converters and switches of the second converter based on control information received from the main control device.

39. The power supply unit of claim 37, wherein the control information comprises at least one of a reference voltage, a reference current, a pulse duration, or a phase angle for the power supply cell.

40. The power supply unit of any of claims 37 to 39, wherein the main control device is configured to generate and send the control information to each local control device based on control signals received from a supervisory control device.

41. The power supply unit of claim 40, wherein the supervisory control device is communicably coupled to one or more chargers configured to charge the plurality of energy sources of each power supply cell, and wherein the supervisory control device is configured to instruct the one or more chargers to charge the plurality of energy sources of each power supply cell between each pulse of electrical energy output by the power supply system.

42. The power supply unit of any one of claims 35 to 41, wherein each power supply cell comprises a crowbar switch electrically coupled between output ports of the power supply cell.

43. The power supply unit of claim 42, wherein each crowbar switch is electrically coupled in parallel with a filter capacitor electrically coupled between the output ports.

44. The power supply unit of claim 42 or 43, further comprising one or more control devices configured to operate each crowbar switch to isolate the plurality of first converters and the second converter of each power supply cell in response to detecting a short circuit condition.

45. The power supply unit of any one of claims 35 to 44, wherein each first converter comprises a two-level boost converter and each second converter comprises a two-level buck converter.

46. The power supply unit of claim 45, wherein each buck converter comprises a multi-phase interleaved buck converter.

47. The power supply unit of any of claims 35 to 44, wherein each first converter comprises a three-level boost converter and the second converter comprises a three-level buck converter.

48. The power supply unit of claim 47, wherein each buck converter comprises a multi-phase interleaved buck converter.

49. The power supply unit of any one of claims 47 or 48, further comprising an intermediate bus and a ground bus.

50. The power supply unit of claim 49, wherein each boost converter comprises a first set of switches electrically coupled between the power bus and the intermediate bus and a second set of switches electrically coupled between the intermediate bus and the ground bus.

51. The power supply unit of claim 50, further comprising a first capacitor electrically coupled between the power bus and the intermediate bus and a second capacitor electrically coupled between the intermediate bus and the ground bus.

52. The power supply unit of any one of claims 49 to 51, wherein the buck converter comprises:
a first pair of switches electrically coupled between the power bus and the intermediate bus;
a second pair of switches electrically coupled between the power bus and the intermediate bus;
a third pair of switches electrically coupled between the intermediate bus and the ground bus; and
a fourth pair of switches electrically coupled between the intermediate bus and the ground bus.

53. The power supply unit of claim 52, further comprising:
a first inductor electrically coupled between a first node between the first pair of switches and a first polarity output bus that is electrically coupled to the load;
a second inductor electrically coupled between a second node between the second pair of switches and the first polarity output bus;
a third inductor electrically coupled between a third node between the third pair of switches and a second polarity output bus that is electrically coupled to the load; and
a fourth inductor electrically coupled between a fourth node between the fourth pair of switches and the second polarity output bus.

54. The power supply unit of claim 53, wherein a first current of the first inductor is phase shifted relative to a second current of the second inductor and a third current of the third inductor is phase shifted relative to a fourth current of the fourth inductor.

55. The power supply unit of any one of claims 14 or 15, wherein each boost converter comprises four switches electrically coupled between the power bus and a ground bus.

56. The power supply unit of any one of claims 47 or 48, wherein each boost converter comprises a first pair of switches, a second pair of switches, and a flying capacitor electrically coupled between a node between the first pair of switches and a node between the second pair of switches.

57. The power supply unit of claim 56, further comprising a pre-charging circuit for pre-charging each flying capacitor.

58. The power supply unit of claim 57, further comprising a control system configured to pre-charge each flying capacitor by closing a switch of each boost converter when charging each energy source.

59. The power supply unit of claim 58, wherein the buck converter comprises:
a first branch of switches electrically coupled between the power bus and the ground bus, the first branch of switches comprising a first pair of switches and a second pair of switches; and
a second branch of switches electrically coupled between the power bus and the ground bus, the second branch of switches comprising a third pair of switches and a fourth pair of switches.

60. The power supply unit of claim 59, further comprising:
a first flying capacitor electrically coupled between a first node between the first pair of switches and a second node between the second pair of switches; and
a second flying capacitor electrically coupled between a third node between the third pair of switches and a fourth node between the fourth pair of switches.

61. The power supply unit of any one of claims 59 or 60, wherein the buck converter comprises:
a first inductor electrically coupled between (i) a fifth node between the first pair of switches and the second pair of switches and (ii) a first polarity output bus that is electrically coupled to the load; and
a second inductor electrically coupled between (i) a sixth node between the third pair of switches and the fourth pair of switches and (ii) the first polarity output bus that is electrically coupled to the load.

62. The power supply unit of claim 61, wherein a first current of the first inductor is phase shifted relative to a second current of the second inductor.

63. The power supply system of any one of claims 35 to 62, further comprising a terminal between each pair of power supply units.

64. The power supply unit of claim 63, wherein each terminal is electrically coupled to the load.

65. The power supply unit of any one of claims 35 to 64, further comprising a charge circuit for each energy source.

66. The power supply unit of claim 65, wherein each charge circuit comprises one more switches for selectively electrically coupling the energy source to a charger.

67. The power supply unit of any one of claims 35 to 66, further comprising a discharge circuit for each energy source, each discharge circuit comprising a discharge switch and a dump resistor for discharging the energy source.

68. A power supply unit, comprising:
a plurality of energy sources;
a plurality of boost converters electrically coupled in parallel, each boost converter being configured to convert electrical energy from at least one of the energy sources and output the converted electrical energy to a power bus; and
a buck converter configured to convert electrical energy of the power bus and regulate output voltage and/or output current of the power cell.

69. A method of providing pulsed power to a load, the method comprising:
charging energy sources of first converters of each of multiple power cells;
operating switches of the first converters of each power cell to generate an output pulse of energy for the load; and
operating switches of a second converter of each power cell to regulate the output pulse of energy for the load.

70. The method of claim 69, wherein each first converter comprises a boost converter and each second converter comprises a buck converter.

72. The method of claim 69, wherein each power cell is configured in accordance with any of claims 1 to 68.

73. The method of any of claims 69 to 72, wherein operating the switches of the first converter and switches of the second converter comprises operating the switches for a specified duration of the pulse of energy.

74. The method of claim of claims 69 to 73, further comprising recharging the energy sources of the first converters of each power cell after the specified duration elapses.
